(19) United States
(12) Patent Application Publication
(10) Pub. No.: US 2019/0347102 A1
(43) Pub. Date: Nov. 14, 2019

(54) ARITHMETIC PROCESSING APPARATUS AND CONTROL METHOD FOR ARITHMETIC PROCESSING APPARATUS

(71) Applicant: FUJITSU LIMITED, Kawasaki-shi (JP)

(72) Inventor: Ryohei Okazaki, Kawasaki (JP)

(73) Assignee: FUJITSU LIMITED, Kawasaki-shi (JP)

(21) Appl. No.: 16/392,677

(22) Filed: Apr. 24, 2019

(30) Foreign Application Priority Data
May 11, 2018 (JP) 2018-091843

(51) Int. Cl. G06F 9/30; G06F 9/52

(52) U.S. Cl. CPC G06F 9/30043; G06F 9/522; G06F 9/30101; G06F 9/3001

(57) ABSTRACT

An arithmetic processing apparatus includes a processor. The processor determines whether or not a fetch instruction satisfies a barrier setting condition, when the fetch instruction satisfies the barrier setting condition, changes the fetch instruction into a barrier instruction to be subjected to a barrier control of a barrier attribute corresponding to a satisfied barrier setting condition, generates an execution instruction by decoding the fetch instruction, allocates the execution instruction and the barrier instruction to execution queue circuits corresponding to respective instructions, when a memory access instruction is input, executes the memory access instruction in an out-of-order different from the order of programs, when the barrier instruction is input, performs a control so that a memory access instruction after the barrier instruction is not speculatively executed to overtake the barrier instruction and a predetermined execution instruction corresponding to the barrier attribute before the barrier instruction.

### CROSS-REFERENCE TO RELATED APPLICATION

This application is based upon and claims the benefit of the prior Japanese Patent Application No. 2018-091843, filed on May 11, 2018, the entire contents of which are incorporated herein by reference.

### FIELD

The embodiments discussed herein are related to an arithmetic processing apparatus and a control method for an arithmetic processing apparatus.

### BACKGROUND

An arithmetic processing device is a processor or a CPU (Central Processing Unit) chip. Hereinafter, the arithmetic processing device will be referred to as a processor. The processor has various structural or control features in order to efficiently execute the instructions of programs. The features include, for example, a pipeline configuration in which a plurality of instructions are processed in parallel at the same time, a configuration that is executed from an instruction that is ready to be executed in an out-of-order without being based on the order (in-order) of the instructions on programs, and a configuration in which an instruction of a branch prediction destination is speculatively executed before the branch condition of a branch instruction is determined.

Meanwhile, the processor has a privileged mode or an OS mode (kernel mode) for executing an OS (Operating System) program in addition to a user mode for executing a user program. An instruction of the user mode is prohibited from accessing a protected memory area that can only be accessed in the privileged mode. When the user mode instruction tries to access the protected memory area, the processor detects an illegal memory access, and traps and cancels the execution of the instruction. Such a configuration prevents data in the protected memory area from being illegally accessed.

Related techniques are disclosed in, for example, Japanese Laid-open Patent Publication Nos. 2000-322257 and 2010-015298, and Jann Horn, “Reading privileged memory with a side-channel,” (online), (searched on May 9, 2018), Internet <https://googleprojectzero.blogspot.jp/2018/01/reading-privileged-memory-with-side.html?m=1>

### SUMMARY

According to an aspect of the embodiments, an arithmetic processing apparatus includes a processor. The processor determines whether or not a fetch instruction satisfies a barrier setting condition, when the fetch instruction satisfies the barrier setting condition, changes the fetch instruction into a barrier instruction to be subjected to a barrier control of a barrier attribute corresponding to a satisfied barrier setting condition, generates an execution instruction by decoding the fetch instruction, allocates the execution instruction and the barrier instruction to execution queue circuits corresponding to respective instructions, when a memory access instruction is input, executes the memory access instruction in an out-of-order different from the order of programs, when the barrier instruction is input, performs a control so that a memory access instruction after the barrier instruction is not speculatively executed to overtake the barrier instruction and a predetermined execution instruction corresponding to the barrier attribute before the barrier instruction.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a view illustrating an example of vulnerability of a processor;

FIG. 2 is a view illustrating an example of a configuration of a processor according to an embodiment;

FIG. 3 is a view illustrating an example of a configuration a barrier setting circuit BA_SET and an instruction decoder I_DEC;

FIG. 4 is a flowchart illustrating an example of an operation of the barrier setting circuit;

FIG. 5 is a view illustrating an example of a configuration of a reservation station RSA and a primary data cache L1_DCACHE;

FIG. 6 is a view illustrating an outline of an order guarantee control (barrier control) in the processor related to a barrier instruction of a BBM attribute;

FIG. 7 is a flowchart of barrier control BC1 for a barrier instruction in RSA;

FIG. 8 is a flowchart of barrier control BC2 for an instruction other than the barrier instruction in RSA;

FIG. 9 is a view illustrating an example of a configuration of input queues of RSA and RSBR;

FIG. 10 is a view illustrating an example of a configuration of input queues of RSA and RSBR;

FIG. 11 is a view illustrating an example of a configuration of input queues of RSA and RSBR;

FIG. 12 is a view illustrating an example of a configuration of input queues of RSA and RSBR;

FIG. 13 is a view illustrating an outline of the order guarantee control (barrier control) in the processor related to a barrier instruction of an MBM attribute;

FIG. 14 is a flowchart of barrier control BC1_B for a barrier instruction in RSA;

FIG. 15 is a view illustrating an example of barrier control in RSA for Example_3 in a case where an instruction attached with an MBM attribute flag is a memory access instruction;

FIG. 16 is a view illustrating an example of barrier control in RSA for Example_3 in a case where an instruction attached with an MBM attribute flag is a memory access instruction;

FIG. 17 is a flowchart illustrating an example of control in a queue FP_QUE of a fetch port of a memory access control circuit;

FIG. 18 is a view illustrating an example of the queue FP_QUE of the fetch port;

FIG. 19 is a view illustrating an outline of the order guarantee control (barrier control) in the processor related to a barrier instruction of an ABM attribute;

FIG. 20 is a flowchart of barrier control BC5 in the fetch port of the memory access control circuit;

FIG. 21 is a view for explaining the barrier control BC5 in the fetch port of the memory access control circuit for Example_4;

FIG. 22 is a view for explaining the barrier control BC5 in the fetch port of the memory access control circuit for Example_4;

FIG. 23 is a view illustrating an outline of the order guarantee control (barrier control) in the processor related to an instruction to which a barrier attribute ABA is added;

FIG. 24 is a flowchart illustrating a barrier instruction (BA instruction) in an instruction decoder and barrier control BC6 for instructions before and after the barrier instruction;

FIG. 25 is a view for explaining the barrier control BC6 for an instruction string of Example_5;

FIG. 26 is a view for explaining the barrier control BC6 for an instruction string of Example_5; and

FIG. 27 is a view for explaining the barrier control BC6 for an instruction string of Example_5.

### DESCRIPTION OF EMBODIMENTS

There is a risk of reading secret data in a protected memory area before the branch condition of the branch instruction is determined, when a load instruction illegally added to the program is speculatively executed. Thereafter, it may be considered that the load instruction is speculatively executed with the secret data as an address.

Alternatively, there is a risk of reading secret data in a protected memory area by an illegal load instruction illegally added to the program before the illegal load instruction is executed and detected by the processor so that a trap occurs. Thereafter, it may be considered that the load instruction is speculatively executed with the secret data as an address.

In the above cases, by the execution of a second load instruction, the data loaded in the cache line of the address of the secret data in the cache memory is registered. Then, after the branch condition of the branch instruction is determined or after the trap occurs, the secret data may be illegally acquired by measuring the latency by reading the data in the cache memory, and detecting an address with a shorter latency.

In order to avoid the vulnerability of the processor as described above, for example, it is necessary to suppress a speculative execution of an illegal memory access instruction (load instruction). In addition, before the completion of the execution of the illegal memory access instruction (load instruction) and detection of the trap, it is necessary to suppress a subsequent memory access instruction (load instruction) from being speculatively executed.

However, speculatively executing a branch prediction destination instruction while the branch destination of the branch prediction destination instruction is undetermined or speculatively executing a next load instruction before the completion of processing of the load instruction is a means for improving the processing efficiency of the processor. Therefore, it is not desirable to uniformly suppress the speculative execution because the program processing efficiency of the processor may be deteriorated. In addition, it may not be a realistic solution to embed an additional code for suppressing the speculative execution in the existing program because embedding additional codes requires substantial man-hours.

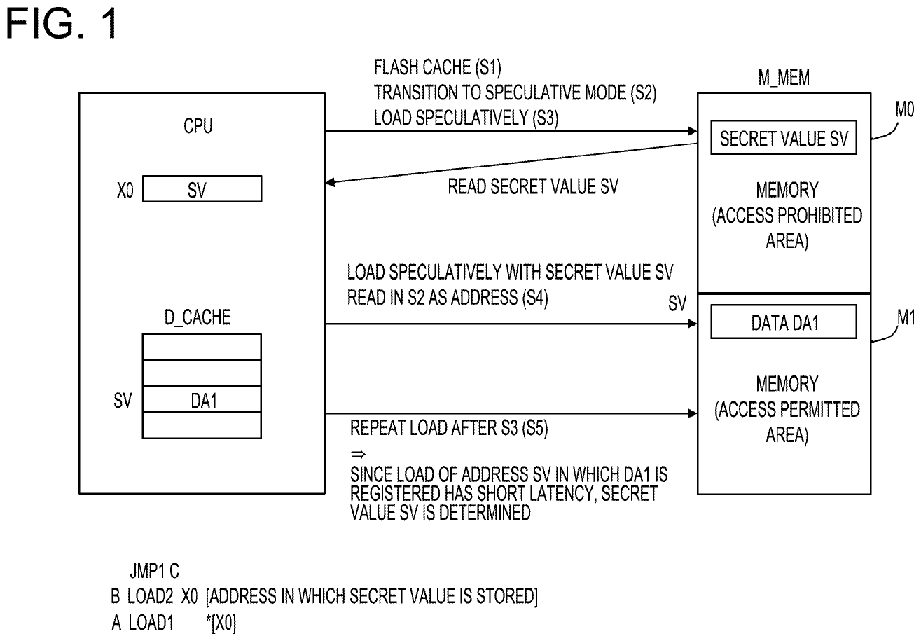

FIG. 1 is a view for explaining an example of vulnerability of a processor. FIG. 1 illustrates a processor CPU and a main memory M_MEM. FIG. 1 further illustrates an example of an instruction string to be executed by the processor CPU.

An example of the instruction string is a first example of an illegal program, and the contents of each instruction are as follows. JMP C // branch instruction to branch to branch destination C // B LOAD2 X0 [address of secret value storage] // Load to address in which secret value is stored and store secret value in register X0 // A LOAD1 * [X0] // load to address of register X0 //

Illegal load instructions “B LOAD2” and “A LOAD1” are added to the above indicated instruction string. Therefore, the illegal program first clears a cache memory (S1) and transitions to a privileged mode (OS mode) (S2). Then, the processor executes a branch instruction JMP C in the privileged mode, but speculatively executes a load instruction LOAD 2 of a branch prediction destination B before a branch destination C of the branch instruction is determined (S3). The branch prediction destination B is illegally registered as branch prediction information, but it is assumed that the correct branch destination of the branch instruction is C.

When the processor speculatively executes the load instruction LOAD2 of the illegal branch prediction destination B (S3), the processor reads a secret value SV in a protected memory area M0 that is permitted to be accessed only in the privileged mode, and stores the secret value SV in a register X0. Further, when the processor speculatively executes the next load instruction A LOAD1, the processor reads data DA1 in a memory area M1 that is permitted to be accessed in the user mode with the secret value in the register X0 as an address (S4). As a result, the data DA1 is registered in the address SV in a cache memory CACHE in the processor.

Thereafter, when the processor repeats a load instruction (not illustrated) while changing the address, the access latency of the load instruction to the address SV in which the data DA1 is registered becomes shorter than those of the other addresses, and thus, the contents of the address SV may be recognized. As a result, the security of the secret value SV is degraded.

When the execution of the branch instruction JMP C is completed after the two load instructions LOAD2 and LOAD1 are speculatively executed, it is determined that the branch prediction destination B was a branch prediction miss, and the state of a speculatively-executed load instruction of a pipeline circuit in the processor is cleared. However, since the cache memory is not cleared, it is possible to acquire the secret value SV based on the latency of the cache memory.

In this manner, the execution of the load instructions LOAD2 and LOAD1 of the illegal branch prediction destination before the branch destination of the branch instruction JMP is determined is one of the causes of processor vulnerability.

A second example of the instruction string that causes the processor vulnerability is as follows. LOAD1 X0 [privileged area] LOAD2 X1 [X0] LOAD1 is a load instruction to store a secret value of the address of the privilege area in the register X0, and LOAD2 is a load instruction to store in a register X1 a value in a memory with a value (secret value) stored in the register X0 as an address. It is assumed that both of the load instructions are executed in the user mode.

In this case, since the first load instruction LOAD1 accesses the protected memory area (privileged area) in the execution in the user mode, a trap occurs during the execution and the pipeline circuit in the processor is cleared. However, when the second load instruction LOAD2 is speculatively executed at a timing when the trap has not yet occurred before the execution of the first load instruction LOAD1 is completed, data in an area with the secret value in the register X0 as an address is registered in the cache. As in the example of FIG. 1, when the processor repeats the load instruction while changing the address, the access latency of the load instruction to the address of the secret value becomes shorter than those of the other addresses, and thus, the secret value of the address may be recognized.

In the instruction string, it is considered that the speculative execution of the second load instruction LOAD2 after the execution of the first load instruction LOAD1 is completed and the trap determination is completed, is the cause of the processor vulnerability. In order to eliminate such vulnerability, the order guarantee control may be performed so that the next load instruction LOAD2 is not executed until the execution of the first load instruction LOAD1 is completed.

In the above two examples, the speculative execution of the instruction causing the processor vulnerability includes (1) a speculative execution of an instruction after the barrier instruction at a stage where the branch destination of the branch instruction before the barrier instruction is not determined and (2) a speculative execution of an instruction after the barrier instruction at a stage where the barrier instruction is trapped and the canceling process is not completed when the barrier instruction executing a memory access accesses an access-prohibited area in a memory. In addition to the above examples, there is a case where a speculative execution of an instruction that occurs under specific circumstances may cause the processor vulnerability.

### EMBODIMENTS

<Processor Configuration>

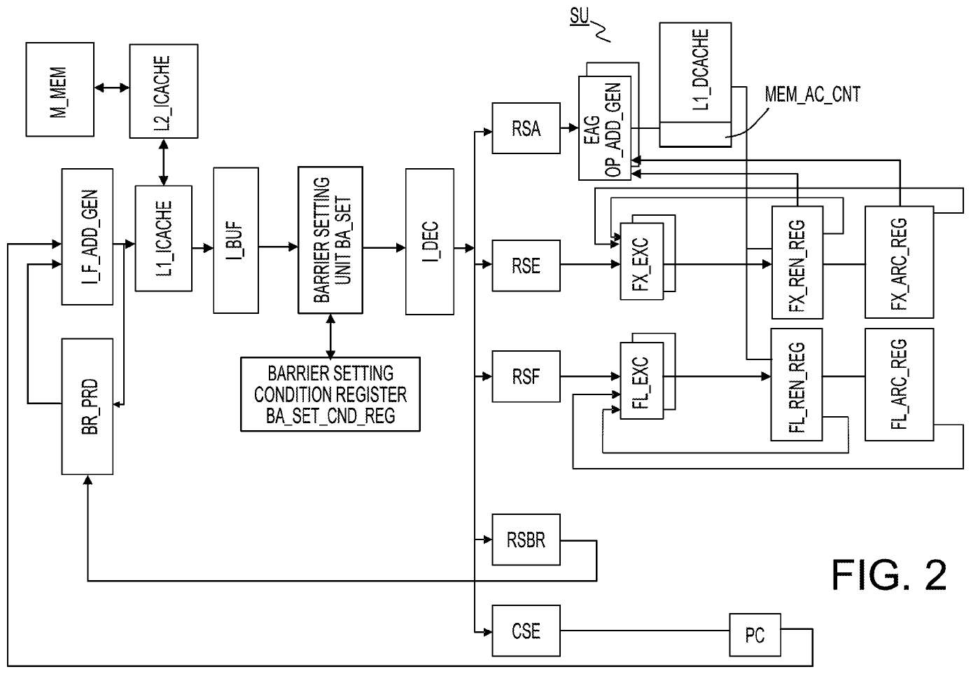

FIG. 2 is a view illustrating an example of a configuration of a processor according to an embodiment. The processor illustrated in FIG. 2 includes a storage unit SU, one or more fixed point arithmetic circuits FX_EXC, and one or more floating point arithmetic circuits FL_EXC.

The storage unit SU includes an operand address generation circuit OP_ADD_GEN including an addition/subtraction circuit for address calculation, and a primary data cache L1_DCACHE. The primary data cache has a memory access control circuit MEM_AC_CNT for controlling an access to a main memory when a cache miss occurs, in addition to a cache memory.

The fixed point arithmetic circuit FX_EXC and the floating point arithmetic circuit FL_EXC have, for example, respective addition/subtraction circuits, logic operation circuits, and multipliers. The floating point arithmetic circuit has, for example, a number of arithmetic circuits corresponding to the SIMD (Single Instruction Multiple Data) width, so that SIMD calculation may be performed.

The overall configuration of the processor will be described below along a processing flow of instructions. An instruction fetch address generation circuit I_F_ADD_GEN generates a fetch address, and temporarily stores in an instruction buffer I_BUF a fetch instruction fetched from a primary instruction cache L1_ICACHE in the order (in-order) of execution in a program. Then, an instruction decoder I_DEC inputs and decodes the fetch instruction in the instruction buffer in the in-order, so as to generate an executable instruction (execution instruction) to which information necessary for execution is added.

In the embodiment, the processor includes a barrier setting circuit BA_SET between the instruction buffer I_BUF and the instruction decoder I_DEC. The barrier setting circuit BA_SET refers to a barrier setting condition set in a barrier setting condition register BA_SET_CND_REG, to determine whether or not the fetch instruction corresponds to (i.e., matches) the barrier setting condition. When it is determined that the fetch instruction corresponds to the barrier setting condition, the barrier setting circuit BA_SET performs a barrier setting such as appending a barrier attribute to the fetch instruction or adding a barrier flow instruction after the fetch instruction. Then, the barrier setting circuit BA_SET outputs the fetch instruction appended with the barrier attribute, and the barrier flow instruction to the instruction decoder I_DEC. The barrier setting circuit BA_SET may be contained in the instruction decoder I_DEC. The barrier setting will be described in more detail later.

Next, the execution instruction generated in the instruction decoder is queued and stored in a storage having a queue structure called a reservation station in an in-order. The reservation station is an execution queue for storing the execution instructions in a queue and is provided for each arithmetic circuit that executes an instruction. The reservation station includes, for example, an RSA (Reservation Station for Address Generation) provided in the storage unit SU including the operand address generation circuit OP_ADD_GEN and the L1 data cache L1_DCAHCE, an RSE (Reservation Station for Execution) provided in the fixed point arithmetic circuit FX_EXC), and an RSF (Reservation Station for Floating Point) provided in the floating point arithmetic circuit FL_EXC. The reservation station further includes an RSBR (Reservation Station for Branch) corresponding to a branch prediction unit BR_PRD.

Hereinafter, the reservation station will be appropriately abbreviated and referred to as an RS.

Then, based on a determination as to whether or not the instruction execution condition is satisfied, such as a determination as to whether or not an input operand necessary for instruction execution is readable out from a general-purpose register file by completion of arithmetic processing of the previous instruction (whether the read-after-write (RAW) constraint is satisfied) or a determination as to whether the circuit resources of an arithmetic circuit is usable, the execution instruction queued in each RS is issued to and executed in an arithmetic circuit in a random order (out-of-order).

Meanwhile, the instruction decoder I_DEC allocates an instruction identification (IID) to an execution instruction generated by decoding the fetch instruction in the order of execution in the program, and transmits the execution instruction to a commit stack entry (CSE) in an in-order. The CSE has a storage of a queue structure in which the transmitted execution instruction is stored in an in-order, and an instruction commit processing unit that performs commit processing (completion processing) of each instruction in response to an instruction processing completion report from the pipeline circuit of the arithmetic circuit based on information in the queue. Therefore, the CSE is a completion processing circuit that performs the instruction completion processing.

The execution instruction is stored in the queue in the CSE in an in-order, and the CSE waits for the instruction processing completion report from each arithmetic circuit. As described above, the execution instruction is transmitted in an out-of-order from each RS to the arithmetic circuit and is executed by the arithmetic circuit. Thereafter, when the instruction processing completion report is sent to the CSE, the instruction commit processing unit of the CSE completes in an in-order the processing of an execution instruction corresponding to the processing completion report among instructions waiting for the processing completion report stored in the queue and updates the circuit resources such as a register.

The processor further includes an architectural register file (or a general register file) ARC_REG accessible from software, and a renaming register file REN_REG for temporarily storing the arithmetic result by the arithmetic circuit. Each register file has a plurality of registers. In addition, each register file is provided to correspond to each of the fixed point arithmetic circuit and the floating point arithmetic circuit.

In order to enable the out-of-order execution of the execution instruction, the renaming register file temporarily stores the arithmetic result, and in the completion processing of the execution instruction, the arithmetic result stored in the renaming register is stored in a register in the architectural register file, and the register in the renaming register file is opened. In addition, the CSE increments a program counter PC in the completion processing.

The branch instruction queued in the branch processing RSBR is branch-predicted by the branch prediction unit BR_PRD, and the instruction fetch address generation circuit I_F_ADD_GEN generates a branch destination address based on the prediction result. As a result, an instruction based on the branch prediction is read out from the instruction cache and speculatively executed by the arithmetic circuit via the instruction buffer and the instruction decoder. The RSBR executes a branch instruction in an in-order. However, before a branch destination of the branch instruction is determined, the branch destination is predicted and an instruction of the predicted branch destination is speculatively executed. When the branch prediction is correct, the processing efficiency increases. Meanwhile, when the branch prediction is incorrect, the speculatively executed instruction is canceled and the processing efficiency decreases. The processing efficiency is improved by increasing the accuracy of branch prediction.

In addition, the processor has a secondary instruction cache L2_CACHE which accesses the main memory M_MEM via a memory access controller (not illustrated). Likewise, the primary data cache L1_DCACHE has a memory access control circuit (not illustrated) in its cache control circuit and is connected to a secondary data cache (not illustrated) to control a memory access to the main memory M_MEM. The memory access control circuit processes a memory access instruction in an in-order.

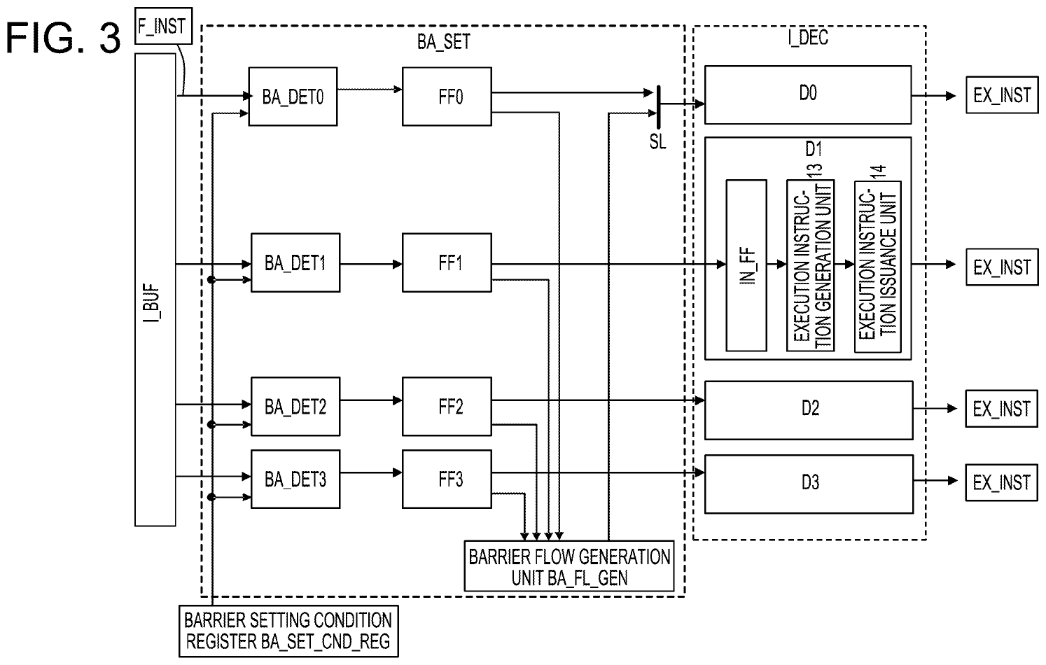

FIG. 3 is a view illustrating an example of a configuration of the barrier setting circuit BA_SET and the instruction decoder I_DEC. The instruction decoder I_DEC decodes a fetch instruction F_INST transferred from the instruction buffer I_BUF to generate an execution instruction EX_INST. In the embodiment, for example, the instruction decoder I_DEC has four slot decoders D0 to D3 in order to increase the processing efficiency of the instruction decoder. Each of the slot decoders D0 to D3 includes an input flip-flop IN_FF for inputting a fetch instruction, an execution instruction generation circuit 13 for decoding the fetch instruction to generate an execution instruction, and an execution instruction issuing circuit 14 that issues the execution instruction to the reservation station of the arithmetic circuit.

The execution instruction EX_INST is an instruction including a decoding result for making an operation code of the fetched instruction F_INST executable. For example, the execution instruction EX_INST is an instruction including information necessary for arithmetic, such as which reservation station is used, which arithmetic circuit is used, and which data is used for an operand. The execution instruction generation circuit 13 decodes the fetched instruction operation code to obtain information necessary for arithmetic execution and generate an execution instruction.

<Barrier Setting Circuit>

In the embodiment, the barrier setting circuit BA_SET is provided between the instruction buffer I_BUF and the instruction decoder I_DEC. The barrier setting circuit BA_SET has a four-slot configuration similarly corresponding to the four-slot instruction decoder I_DEC. The barrier setting circuit BA_SET includes barrier determination circuits BA_DET0 to BA_DET3 for determining whether or not the fetch instruction corresponds to (or matches) the barrier setting condition and appending a barrier attribute to the fetch instruction when the fetch instruction corresponds to the barrier setting condition, and flip-flops FF0 to FF3 for temporarily latching the fetch instruction appended with the barrier attribute. The barrier determination circuits and the flip-flops also have a 4-slot configuration in accordance with the 4-slot configuration of the instruction decoder I_DEC. However, when the instruction decoder has a one-slot configuration, the barrier determination circuits may also have a one-slot configuration.

Each barrier determination circuit BA_DET determines whether or not the fetch instruction input in an in-order from the instruction buffer corresponds to the barrier setting condition set in the barrier setting condition register BA_SET_CND_REG. The barrier setting condition set in the barrier setting condition register is, for example, an operation code of an instruction corresponding to the barrier setting condition or, conversely, an operation code masked from the barrier setting condition. In this case, the barrier determination circuit determines whether or not the fetch instruction matches the operation code corresponding to the barrier setting condition or whether or not the fetch instruction matches the masked operation code.

The barrier setting condition is, for example, an exceptional level such as a privileged mode having a higher level than the normal mode (user mode), a contents ID specifying a user program (user process), or the like. In this case, the barrier determination circuit determines whether the fetch instruction is an instruction of the exceptional level or an instruction of the contents ID.

The barrier setting condition set in the barrier setting condition register is different for each order guarantee attribute indicating the type of guarantee of the execution order of instructions. When the fetch instruction corresponds to the above-described barrier determination condition, the barrier determination circuit appends the order guarantee attribute (or barrier attribute) corresponding to the corresponding barrier determination condition to the fetch instruction. Appending the barrier attribute signifies adding a barrier attribute flag to the fetch instruction. Then, the barrier determination circuit transfers an instruction appended with the barrier attribute flag to the flip-flops FF0 to FF3. A determination process by the barrier determination circuit will be described later.

The instruction appended with the barrier attribute flag by the barrier determination circuit is executed so that an order guarantee corresponding to the barrier attribute may be implemented in, for example, RS (RSA) corresponding to the storage unit SU. Briefly speaking, the order guarantee of instructions, the instruction appended with the order guarantee attribute, is executed in a form or order conforming to the order guarantee corresponding to the order guarantee attribute (barrier attribute) in the RS (RSA) or the storage unit SU, so that the speculative execution of instructions is suppressed. Even for the processing of instructions in an in-order by the instruction decoder, a predetermined constraint of the order guarantee is imposed to suppress the speculative execution of instructions.

As illustrated in FIG. 3, the barrier setting circuit BA_SET has a barrier flow generation circuit BA_FL_GEN. The barrier flow generation circuit BA_FL_GEN determines whether or not a barrier attribute flag-appended instruction latched by the flip-flops FF0 to FF3 is a memory access instruction, and when it is determined that the corresponding instruction is an instruction other than a memory access instruction, the barrier flow generation circuit BA_FL_GEN additionally generates a barrier flow instruction.

The barrier flow instruction is an instruction for imposing the constraint of the order guarantee, and the barrier attribute flag-appended instruction is also an instruction for imposing the constraint of the order guarantee. Both of the barrier flow instruction and the barrier attribute flag-appended instruction are a kind of barrier instructions having a barrier attribute.

As described above, the barrier determination circuit determines whether or not the four in-order fetch instructions input from the memory buffer correspond to the barrier setting condition (whether or not the corresponding instructions are order guarantee-targeted instructions). When it is determined that none of the four fetch instructions correspond to the barrier setting condition, the fetch instructions are input, as they are, to the four slots of the instruction decoder I_DEC in parallel.

When it is determined in the barrier determination circuit that any one of the four fetch instructions corresponds to the barrier setting condition, a barrier attribute flag is appended to the fetch instruction. When the barrier attribute flag-appended fetch instruction for barrier control on the memory access instruction is a memory access instruction, there is no need to add a barrier flow instruction. In that case, four instructions including a barrier attribute flag-appended memory access instruction are input to the four slots of the instruction decoder I_DEC in parallel. The barrier attribute flag-appended memory access instruction is a barrier instruction for executing a memory access, and accordingly, the order guarantee control is imposed in, for example, RSA.

Meanwhile, when the barrier attribute flag-appended fetch instruction for barrier control on the memory access instruction is an instruction other than a memory access instruction, the barrier flow generation circuit generates a barrier flow instruction. As a result, the barrier setting circuit BA_SET outputs the barrier flow instruction, in addition to the four fetch instructions input from the instruction buffer. In that case, in the first clock cycle, a fetch instruction before the barrier flow instruction is input from the flip-flops to the corresponding slot of the instruction decoder I_DEC, and in the next clock cycle, the barrier flow instruction is input to the slot D0 of the instruction decoder via a selector SL. Then, in the next clock cycle, a fetch instruction after the barrier flow instruction is input to the corresponding slot of the instruction decoder. The barrier flow instruction is a barrier instruction for barrier control, and accordingly, the order guarantee control is imposed in, for example, RSA.

When the barrier attribute flag is a barrier attribute (ABA) for barrier control on all instructions to be described later, there is no need to add a barrier flow instruction.

As will be described later, in a case of barrier attributes of BBM, MBM, and ABM for barrier control on a memory access instruction to be described below, a barrier instruction which is subjected to the control of the order guarantee corresponding to the barrier attribute includes a memory access instruction appended with barrier attribute and a barrier flow instruction. Meanwhile, in a case of a barrier attribute of ABA for barrier control on all instructions, the barrier instruction includes an instruction appended with barrier attribute.

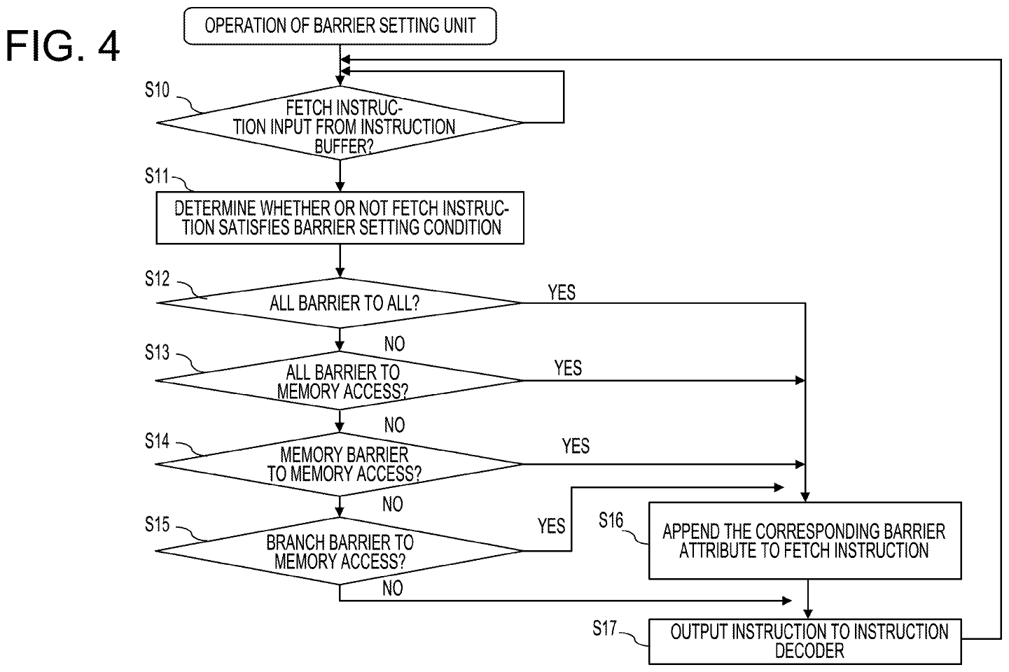

FIG. 4 is a flowchart illustrating an example of an operation of the barrier setting circuit. In the barrier setting circuit BA_SET, when the four in-order fetch instructions are input from the instruction buffer (S10), the barrier determination circuit BA_DET determines whether or not the fetch instructions correspond to (or match) the barrier setting condition set in the barrier setting condition register BA_SET_CND_REG (S11). As described above, the barrier setting condition is set for each of a plurality of order guarantee attributes (barrier attributes). The barrier determination circuit may individually determine the barrier setting conditions of the plurality of order guarantee attributes or may preferentially determine an order guarantee attribute having a stronger order regulation.

In the embodiment, a stronger order guarantee attribute is preferentially set. The order guarantee attribute of the embodiment is of the following four types in the order of weaker order regulation. Branch Barrier to memory access (BBM): Barrier attribute of branch instruction versus memory access instruction, Memory Barrier to memory access (NBM): Barrier attribute of memory access instruction versus memory access instruction, All Barrier to memory access (ABM): Barrier attribute of all instructions versus memory access instruction, and All Barrier to All (ABA): Barrier attribute of all instructions versus all instructions.

The order guarantee contents of the above four order guarantee attributes (barrier attributes) are as follows. The order guarantee may be already defined in the ISA (Instruction Set Architecture) adopted by the processor's hardware or may be uniquely defined by the hardware.

In the case of Branch Barrier to memory access (BBM), the processor performs the order guarantee control (or barrier control) to guarantee that a memory access instruction after an instruction appended with the barrier attribute flag is not speculatively executed to overtake a branch instruction before the instruction appended with the barrier attribute flag.

In the case of Memory Barrier to memory access (MBM), the processor performs the order guarantee control to guarantee that a memory access instruction after an instruction appended with the barrier attribute flag is not speculatively executed to overtake a memory access instruction before the instruction appended with the barrier attribute flag.

In the case of All Barrier to memory access (ABM), the processor performs the order guarantee control to guarantee that a memory access instruction after an instruction appended with the barrier attribute flag is not speculatively executed to overtake all instructions before the instruction appended with the barrier attribute flag.

In the case of All barrier to All access (ABA), the processor performs the order guarantee control to guarantee that all instructions after an instruction appended with the barrier attribute flag is not speculatively executed to overtake all instructions before the instruction appended with the barrier attribute flag.

Since the instruction execution order guarantee as described above is imposed on the barrier attribute flag-appended instruction (including the barrier attribute flag instruction and the barrier flow instruction, hereinafter referred to simply as a barrier instruction), ABA is the strongest order regulation, and the order regulation becomes weaker in the order of ABM, MBM, and BBM.

As illustrated in FIG. 4, when it is determined that the fetch instruction corresponds to the barrier setting condition of All Barrier All (ABA) (“YES” in S12), the barrier determination circuit of the barrier setting circuit appends the barrier attribute flag of All Barrier to All (ABA) to the fetch instruction, regardless of whether or not the fetch instruction corresponds to the barrier setting conditions of the other barrier attributes (S16).

When it is determined that the fetch instruction does not correspond to the barrier setting condition of ABA (“NO” in S12) and corresponds to the barrier setting condition of All Barrier to memory access (ABM) (YES in S13), the barrier determination circuit appends the barrier attribute flag of All Barrier to memory access (ABM) to the fetch instruction, regardless of whether or not the fetch instruction corresponds to the barrier setting conditions of the remaining barrier attributes (S16).

When it is determined that the fetch instruction does not correspond to the barrier setting condition of ABM (“NO” in S13) and corresponds to the barrier setting condition of Memory Barrier to memory access (MBM) (“YES” in S14), the barrier determination circuit appends the barrier attribute flag of Memory Barrier to memory access (MBM) to the fetch instruction, regardless of whether or not the fetch instruction corresponds to the barrier setting conditions of the remaining barrier attributes (S16).

Similarly, when it is determined that the fetch instruction does not correspond to the barrier setting condition of MBM (“NO” in S14) and corresponds to the barrier setting condition of Branch Barrier to memory access (BBM) (“YES” in S15), the barrier determination circuit appends the barrier attribute flag of Branch Barrier to memory access (BBM) to the fetch instruction (S16).

When it is determined that the fetch instruction does not correspond to any barrier setting conditions of the barrier attributes (“NO” in S15), the barrier determination circuit does not append a barrier attribute flag to the fetch instruction.

Then, the barrier determination circuit outputs the fetch instruction, the barrier attribute-appended fetch instruction, and the barrier flow instruction to the instruction decoder I_DEC (S17). In this case, the barrier attribute flag-appended memory access instruction (barrier instruction for executing a memory access) is output, as it is, to the instruction decoder. When the barrier attribute flag-appended instruction is an instruction other than the memory access instruction, the barrier attribute flag-appended instruction and the barrier flow instructions added behind that are output to the instruction decoder.

Here, all of the above-mentioned barrier attribute flag-appended memory access instruction, barrier flow instruction and barrier attribute flag-appended instruction belong to a barrier instruction subjected to barrier control. The barrier instruction referred simply to as herein includes a barrier instruction (barrier attribute flag-appended memory access instruction) for executing a memory access and a barrier instruction (barrier flow instruction) for barrier control in the barrier attributes BBM, MBM and ABM, and further includes a barrier attribute ABA-appended barrier instruction in the barrier attribute ABA. All of these barrier instructions are constrained by the order control of the corresponding order guarantee attribute (barrier attribute).

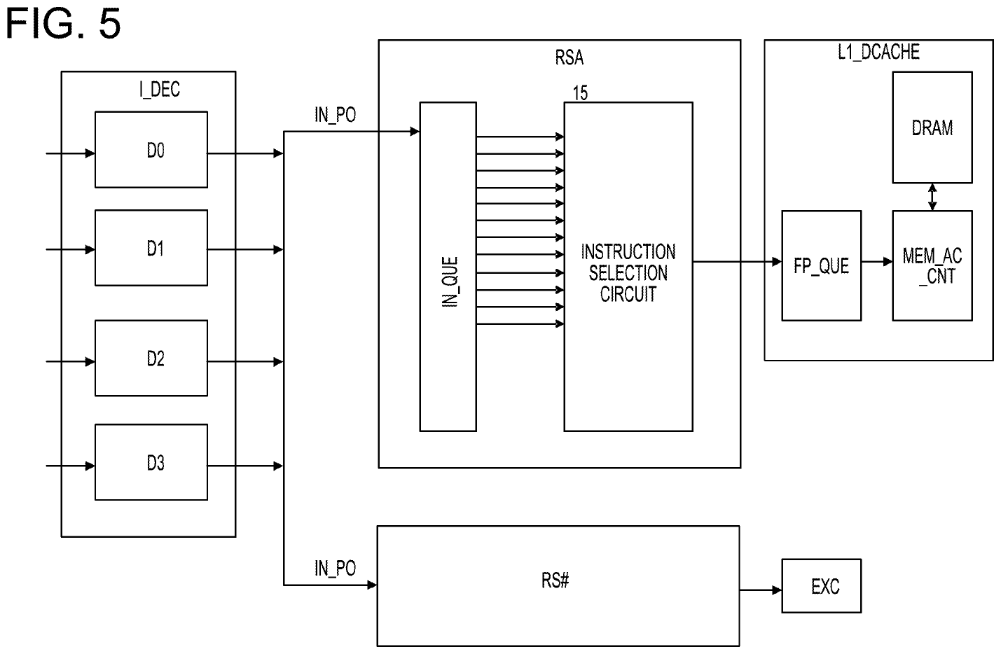

FIG. 5 is a view illustrating an example of a configuration of the reservation station RSA and the primary data cache L1_DCACHE. The reservation station RSA has an input port IN_PO to which an execution instruction issued by the instruction decoder I_DEC is input, and an input queue IN_QUE for storing execution instructions input from the input port IN_PO. A memory access instruction is input to the RSA. Further, the RSA has an instruction selection circuit 15 that selects the oldest instruction out of instructions prepared for execution among the instructions stored in the input queue and issues the selected instruction to the primary data cache. As a result, the instructions stored in the input queue are issued to the primary data cache in an out-of-order.

A reservation station RS# provided in the other arithmetic circuit EXC has the same configuration and performs the same instruction issuance control.

The memory access instruction issued from the RSA is subjected to the necessary address calculation by the operand address generation circuit (see FIG. 2) and input to a queue FP_QUE in a fetch port in the primary data cache L1_DCACHE together with an access destination address. The memory access instruction entered into the fetch port queue is issued to the memory access control circuit MEM_AC_CNT. Then, the memory access control circuit makes a cache determination as to whether or not the data of the access address has been registered in a data RAM (D_RAM) which is a cache memory. When a cache hit occurs, the memory access control circuit reads the data in the cache memory and stores the data in the general purpose register. When a cache miss occurs, the memory access control circuit issues a memory access request to the secondary data cache or the main memory. The data acquired by the memory access is registered in the L1 data cache.

The issuance of the barrier instruction (barrier attribute flag-appended memory access instruction or barrier flow instruction) is controlled, for example, in accordance with the order guarantee of instruction execution in the RSA. With the issuance control, the RSA issues the barrier instruction and its related instruction not in an out-of-order, but in an in-order which is an order based on the order guarantee of the barrier attribute appended to the barrier instruction. Further, if necessary, the fetch port queue FP_QUE in the primary data cache L1_DCACHE waits for completion of a memory access instruction before the memory access instruction issued from the RSA and performs the memory access instruction issuance control so as to execute the next memory access instruction.

However, since the barrier instruction of the All Barrier to All (ABA) attribute also includes an instruction other than the memory access instruction and is not necessarily queued in the RSA, the issuance control according to the order guarantee in the instruction decoder I_DEC is performed.

Hereinafter, a control on how to guarantee the order of instructions of the four kinds of barrier attributes BBM, MBM, ABM and ABA will be described.

<Branch Barrier to Memory Access (BBM)>

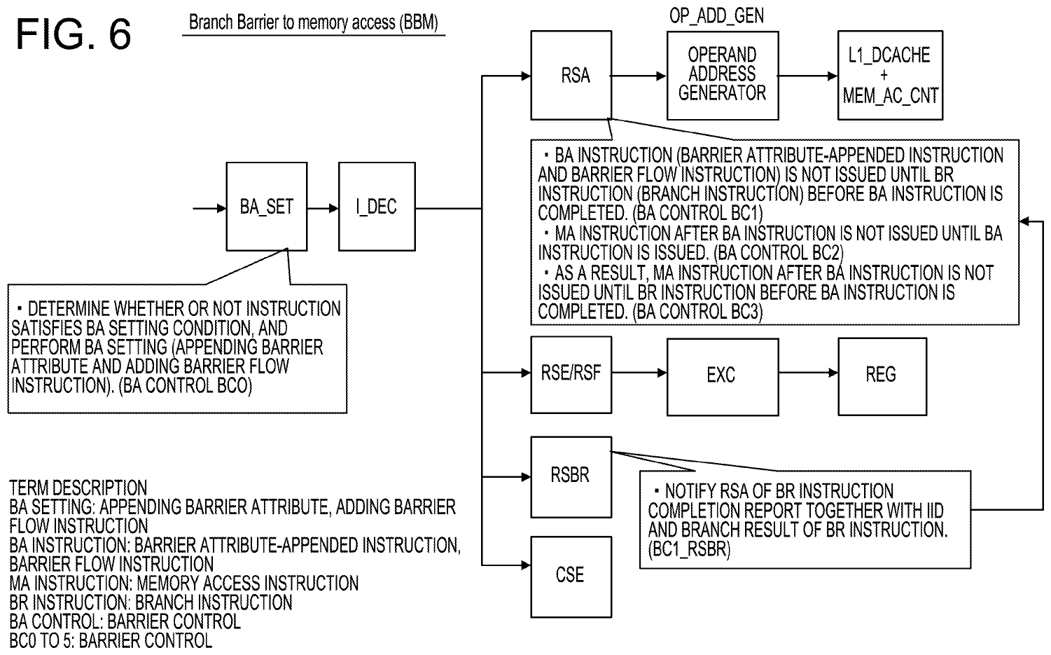

FIG. 6 is a view illustrating an outline of the order guarantee control (barrier control) in the processor related to a barrier instruction of the BBM attribute. First, as described above, the barrier setting circuit BA_SET determines whether or not the fetch instruction input from the instruction buffer corresponds to the barrier setting condition of BBM. When the fetch instruction corresponds to the barrier setting condition of BBM, the barrier setting circuit BA_SET performs barrier setting (barrier control BA0).

In the case of the BBM attribute, the processor performs the order guarantee control to guarantee that a memory access instruction after an instruction appended with the barrier attribute flag is not speculatively executed to overtake a branch instruction before the instruction appended with the flag. For the order guarantee control, when a barrier instruction is included in an execution instruction input from the instruction decoder I_DEC, the RSA firstly does not issue the barrier instruction until the branch instruction before the barrier instruction is completed (BC1), and secondly does not issue a memory access instruction after the barrier instruction until the barrier instruction is issued (BC2). As a result, the RSA does not issue a memory access instruction after the barrier instruction until the execution of the branch instruction before the barrier instruction is completed (BC3). In brief, the RSA performs the first barrier control BC1 and the second barrier control BC2 so as not to issue a memory access instruction after the barrier instruction until the execution of the branch instruction before the barrier instruction is completed (BC3). The barrier control BC3 may be performed as control other than the first and second barrier controls BC1 and BC2.

Further, for the order guarantee control, the branch instruction RS (RSBR) notifies the commit stack entry CSE and the RSA of a branch instruction processing completion report together with an instruction ID (IID) of the branch instruction and a branch result (BC1_SSE). In response to the branch instruction processing completion report (with IID) from the RSBR, the CSE performs a branch instruction completion processing (commit processing) in an in-order. The RSBR processes branch instructions in an in-order. As a result, the branch instruction completion processing is performed in an in-order between branch instructions. Then, similarly to the notification to the CSE, after the branch instruction completion processing, the RSBR notifies the RSA of a branch instruction completion report together with the instruction ID (IID) of the branch instruction and the branch result. The RSA interlocks the barrier instruction to prohibit issuance of the barrier instruction. Then, upon receiving the branch instruction completion report from the RSBR, the RSA determines whether or not the barrier instruction matches the IID of the branch instruction immediately before the barrier instruction. When the barrier instruction matches the IID of the branch instruction immediately before the barrier instruction, the RSA issues the barrier instruction to the L1 data cache L1_DCACHE (BC1).

Hereinafter, the above barrier control will be described by way of specific examples.

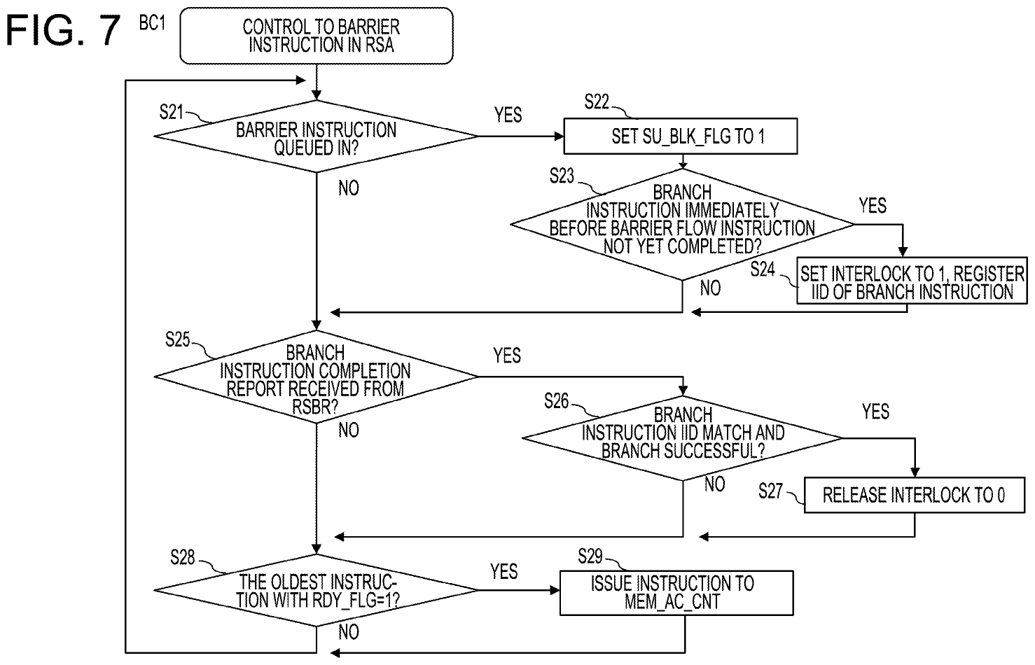

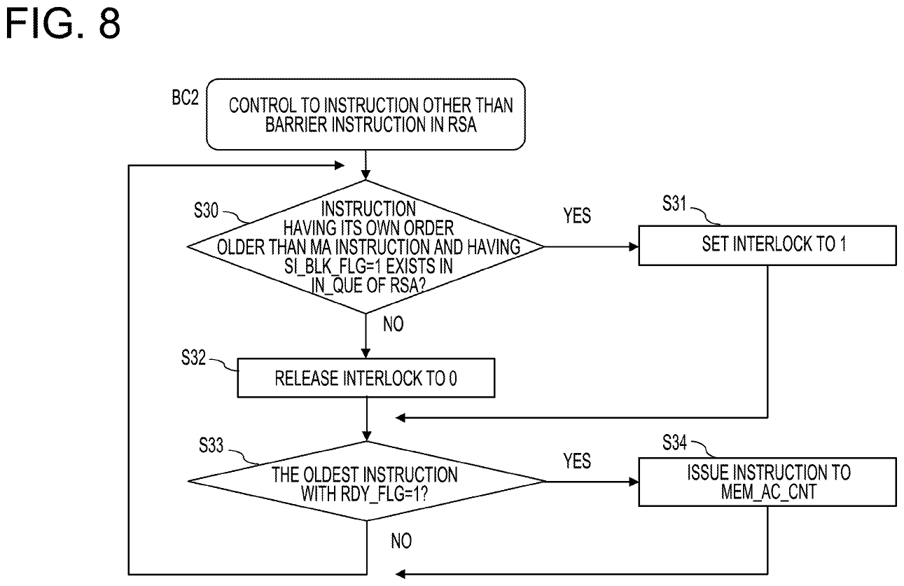

FIG. 7 is a flowchart of the barrier control BC1 for the barrier instruction in the RSA. FIG. 8 is a flowchart of the barrier control BC2 for instructions other than the barrier instruction in the RSA. The barrier controls BC1, BC2, and BC3 in the RSA will be described by way of two specific examples with reference to these flowcharts.

### Example_1: In Case where an Instruction Appended with a Barrier Attribute Flag is a Branch Instruction

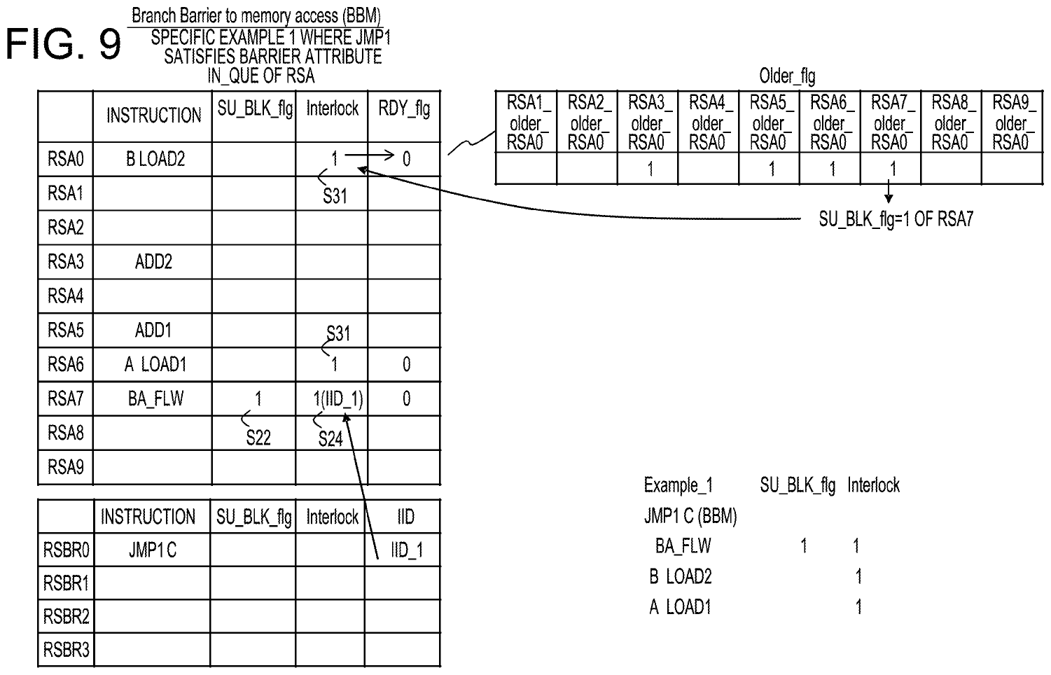

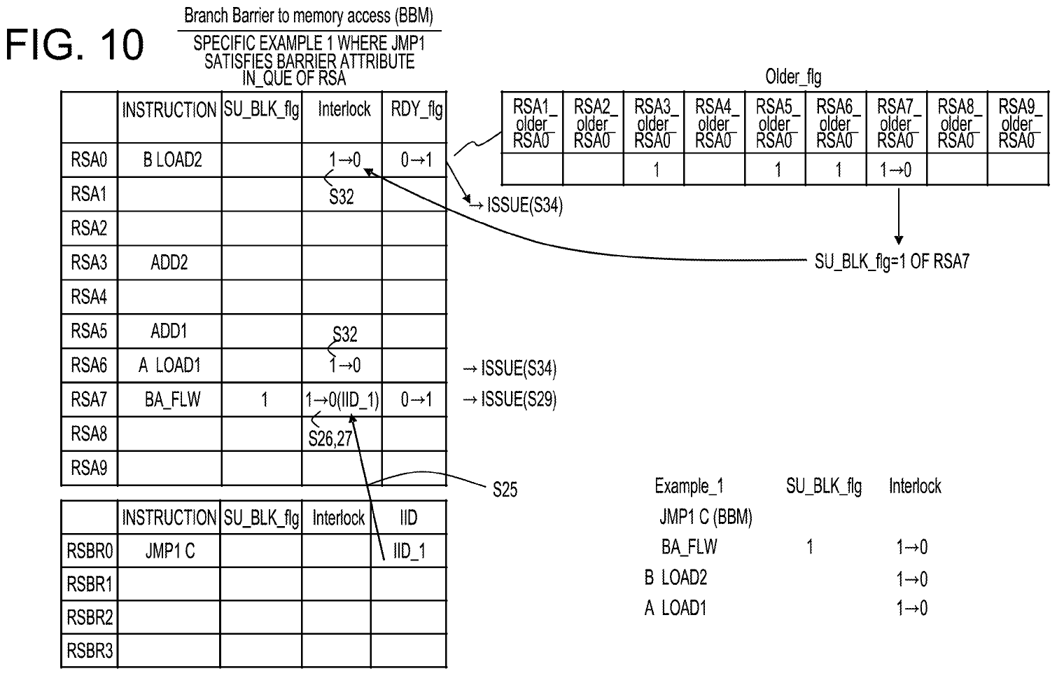

FIGS. 9 and 10 are views illustrating an example of a configuration of input queues of RSA and RSBR. FIG. 9 illustrates an instruction string having a branch instruction JMP1 C and two load instructions B LOAD2 and A LOAD1 illustrated in FIG. 1 as Example_1. In Example_1, the branch instruction JMP1 C other than the memory access instruction corresponds to the BBM attribute and is appended with a barrier attribute flag. Therefore, the barrier setting circuit BA_SET adds a barrier flow instruction BA_FLW and outputs the branch instruction JMP1 C, the barrier flow instruction BA_FLW, and the memory access instructions B LOAD2 and B LOAD1 to the instruction decoder I_DEC. In this case, the barrier flow instruction becomes a barrier instruction.

The input queue IN_QUE of the RSA in FIG. 9 queues instructions issued in an in-order by the instruction decoder to ten entries RSA0 to RSA9. Since instructions are issued in an out-of-order from the input queue IN_QUE, the instructions queued in the input queue are not necessarily stored in the order of the entries RSA0 to RSA9. The barrier flow instruction BA_FLW and the two load instructions B LOAD2 and A LOAD1 of the instruction string are stored in the input queue of the RSA. Addition instructions ADD1 and ADD2 are, for example, instructions before the branch instruction JMP1 C and are executed by the operand address generation circuit, with no particular relation to the barrier control.

The input queue IN_QUE of the RSA appends to the queued instructions, for example, a storage unit block flag SU_BLK_flg for prohibiting issuance to a storage unit (L1 data cache), an interlock flag Interlock for prohibiting issuance from the RSA, and a ready flag RDY_flg indicating that the issuance from the RSA has been ready for. The ready flag is a flag indicating a state where an instruction can be issued from the RSA. In addition to an interlock issuance-prohibited state, the condition of the issuable state (ready state) is that the read-after-write is solved, etc. In addition, the RSA issues the oldest instruction whose ready flag is in the issuable state “1.”

Further, the input queue IN_QUE associates each of the queued instructions with an order flag Older_flg indicating whether or not an instruction older than the queued instruction (in front of the queued instruction) exists in another entry. In FIG. 9, an older flag Older_flg having a flag “1” is illustrated in the entries RSA3, 5, 6 and 7 of an instruction earlier (older) than the load instruction B LOAD2 of the entry RSA0. Other instructions are associated with an order flag, but are not illustrated in FIG. 9.

The barrier flow instruction BA_FLW which is a barrier instruction is queued in and the RSA generates an entry thereof in the input queue (S21 in FIG. 7). The RSA generates an entry in the barrier instruction with a storage unit block flag (SU block flag) as SU_BLK_flg=1. Then, since the branch instruction JMP1 C immediately before the barrier flow instruction BA_FLW has not yet been completed (“YES” in S23), the RSA sets the interlock to Interlock=1, stores the IID of the branch instruction JMP1 C (S24), and suppresses issuance until the branch instruction JMP1 C is completed. As described above, since the RSBR completes processing between branch instructions in an in-order, the completion of the branch instruction immediately before the barrier instruction signifies that all branch instructions before that have also been completed. Therefore, by monitoring that the branch instruction immediately before the barrier instruction has been completed, it is possible to detect the completion of all the branch instructions before the barrier instruction. When the interlock is set to Interlock=1, the ready flag RDY_flg is set to “0” which is not the issuance ready state.

Meanwhile, in FIG. 8, the RSA determines whether or not an instruction having its own order older than (in front of) the memory access instructions B LOAD2 and A LOAD1 after the barrier flow instruction BA_FLW and having SU_BLK_flg=1 exists in the input queue IN_QUE (S30). When the determination result is true (“YES” in S30), the RSA sets the interlocks of these memory access instructions B LOAD2 and A LOAD1 to Interlock=1 (S31). By the Interlock=1, the ready flag becomes RDY_flg=0, and the memory access instruction after these barrier flow instructions cannot be issued from the RSA.

Next, transition is made to the input queue state of FIG. 10. In FIG. 7, when the branch instruction JMP1 C has been completed with successful branch prediction, the RSA receives from the RSBR a report that the IID of JMP1 C has been completed with the successful branch prediction (“YES” in S25). Then, the RSA detects that the IID of the completion report matches the cause IID of the interlock of the entry of the barrier flow instruction BA_FLW (“YES” in S26), and releases the interlock of the barrier flow instruction BA_FLW to Interlock=0 (S27). Thereafter, the RSA detects that the barrier flow instruction is the oldest instruction with the ready flag RDY_flg=1 (“YES” in S28), and issues the barrier flow instruction to the memory access control circuit MEM_AC_CNT of the L1 data cache (S29).

Since the barrier flow instruction disappears from the input queue when the barrier flow instruction is issued from the RSA, the older flag Older_flg of the entry of each RSA is also updated, and the interlocks of the memory access instructions B LOAD2 and A LOAD1 are released to Interlock=0 (“NO” in S31 and S32 of FIG. 8). As a result, the ready flags of the memory access instructions B LOAD2 and A LOAD1 become RDY_flg=1 and can be issued from the RSA (“YES” in S33, S34).

With the barrier control described above, the RSA does not issue the barrier flow instruction until the processing of the branch instruction before the barrier flow instruction is completed, and does not issue a memory access instruction after the barrier flow instruction until the barrier flow instruction is issued. As a result, the RSA does not issue a memory access instruction after the branch instruction until the processing of the branch instruction JMP1 C (BBM) appended with the BBM attribute flag is completed. As a result, the memory access instructions B LOAD2 and A LOAD1 after the branch instruction JMP1 C (BBM) appended with the barrier attribute flag of BBM are not speculatively executed to overtake a branch instruction before the branch instruction of the barrier attribute flag of BBM.

### Example_2: In Case where an Instruction Appended with a Barrier Attribute Flag is a Memory Access Instruction

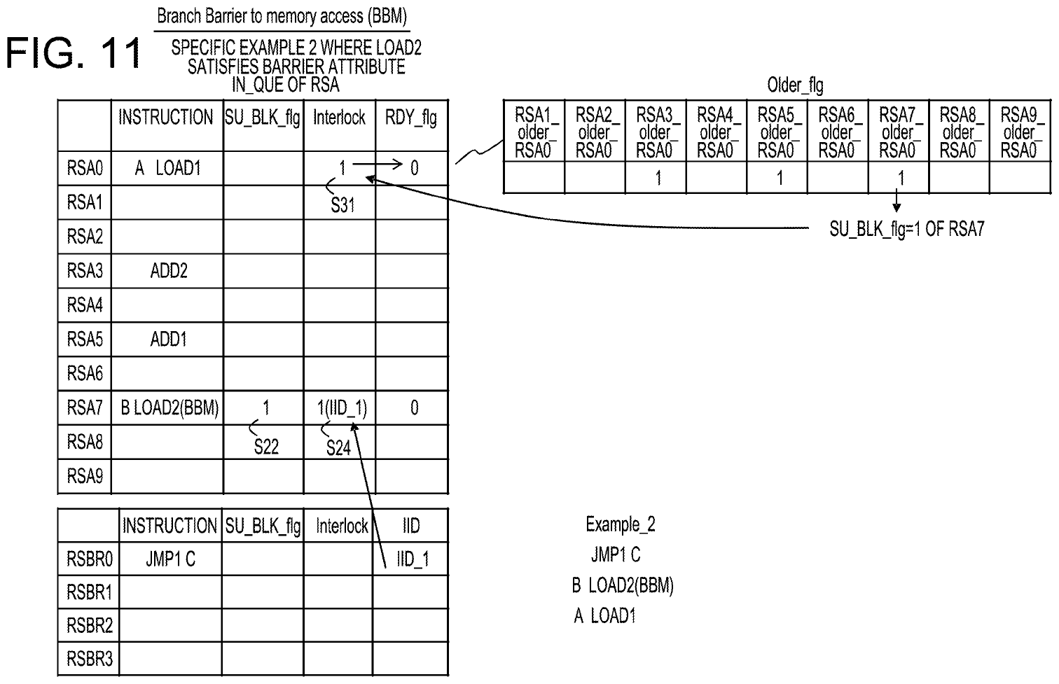

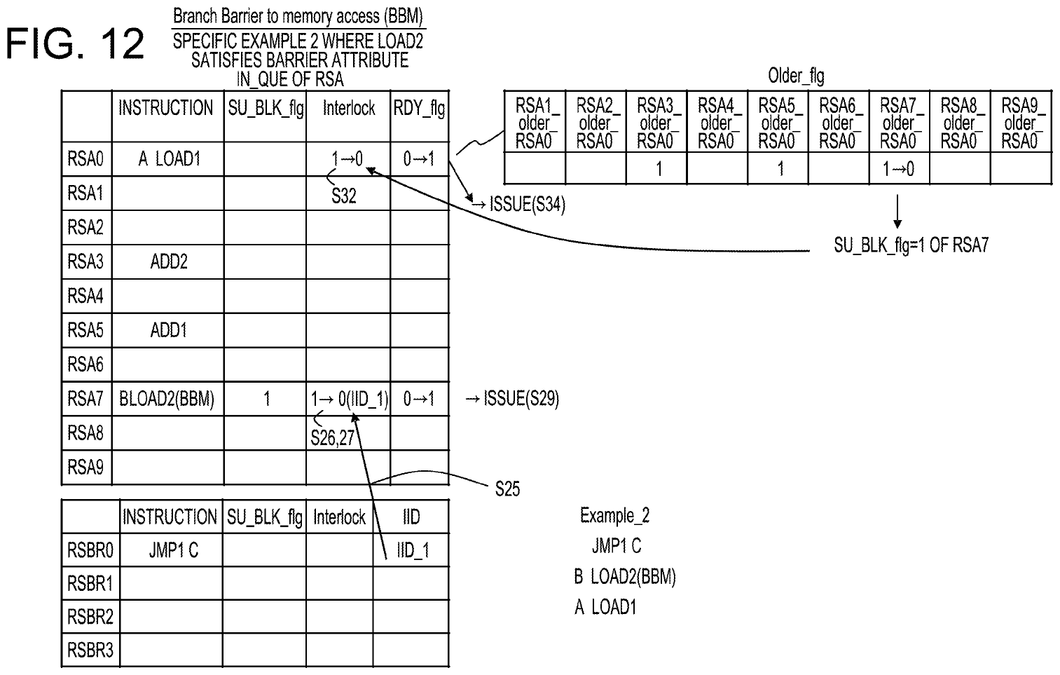

FIGS. 11 and 12 are views illustrating an example of a configuration of input queues of RSA and RSBR. FIG. 11 illustrates an instruction string having a branch instruction JMP C and two memory access (load) instructions B LOAD2 and A LOAD1 illustrated in FIG. 1 as Example_2. In Example_2, since the first memory access instruction B LOAD2 corresponds to the BBM attribute and is appended with the BBM attribute flag, the barrier instruction is an example of the memory access instruction. In this case, the barrier setting circuit BA_SET does not add the barrier flow instruction BA_FLW and outputs the branch instruction JMP1 C, the BBM attribute flag-appended memory access instruction B LOAD2 (BBM), and the subsequent memory access instruction B LOAD1 to the instruction decoder I_DEC. Then, the instruction decoder allocates the branch instruction JMP1 C to the RSBR and issues the two memory access instructions B LOAD2 (BBM) and B LOAD1 to the RSA.

The barrier controls BC1 and BC2 in the RSA are the same as those illustrated in FIGS. 7 and 8 described in Example_1. The processing for the branch instruction in the RSBR is also the same as that in Example_1.

The barrier attribute flag-appended memory access instruction B LOAD2 (BBM) which is the barrier instruction is queued in, and the RSA generates an entry thereof in the input queue (S21 in FIG. 7). The RSA generates an entry in the memory access instruction B LOAD2 (BBM) which is the barrier instruction, with the SU block flag as SU_BLK_flg=1. Then, since the branch instruction JMP1 C immediately before the memory access instruction B LOAD2 (BBM) has not yet been completed (“YES” in S23), the RSA sets the interlock of the memory access instruction B LOAD2 (BBM) to Inerlock=1, stores the IID of the branch instruction JMP1 C (S24), and suppresses issuance of the memory access instruction B LOAD2 (BBM) until the branch instruction JMP1 C is completed. When the interlock is set to Interlock=1, the ready flag RDY_flg is set to “0” which is not the issuance ready state.

Meanwhile, in FIG. 8, the RSA determines whether or not an instruction having its own order older than (in front of) the memory access instruction A LOAD1 after the memory access instruction B LOAD2 (BBM) which is the barrier instruction and having SU_BLK_flg=1 exists in the input queue IN_QUE (S30). When the determination result is true (“YES” in S30), the RSA sets the interlocks of the memory access instruction A LOAD1 to Interlock=1 (S31). By the Interlock=1, the ready flag becomes RDY_flg=0, and the subsequent memory access instruction A LOAD1 cannot be issued from the RSA.

Next, transition is made to the input queue state of FIG. 12. In FIG. 7, when the branch instruction JMP1 C has been completed with successful branch prediction, the RSA receives from the RSBR a report that the IID of JMP1 C has been completed with the successful branch prediction (“YES” in S25). Then, the RSA detects that the IID of the completion report matches the IID stored in the memory access instruction B LOAD2 which is the barrier instruction (“YES” in S26), and releases the interlock of the memory access instruction B LOAD2 (BBM) to Interlock=0 (S27). Thereafter, the RSA detects that the memory access instruction B LOAD2 (BBM) is the oldest instruction with the ready flag RDY_flg=1 (“YES” in S28) and issues the memory access instruction B LOAD2 (BBM) to the memory access control circuit MEM_AC_CNT of the L1 data cache (S29).

Since the memory access instruction B LOAD2 disappears from the input queue when the memory access instruction is issued from the RSA, the older flag Older_flg of the entry of each RSA is also updated, and the interlock of the subsequent memory access instruction A LOAD1 is released to Interlock=0 (“NO” in S30 and S32 of FIG. 8). As a result, the ready flag of the subsequent memory access instruction A LOAD1 becomes RDY_flg=1 and can be issued from the RSA (“YES” in S33 and S34).

With the barrier control described above, the RSA does not issue the memory access instruction B LOAD2 (BBM) which is the barrier instruction until the processing of the branch instruction before the memory access instruction B LOAD2 (BBM) which is the barrier instruction is completed, and does not issue the memory access instruction A LOAD1 after the memory access instruction B LOAD2 (BBM) until the memory access instruction B LOAD2 (BBM) which is the barrier instruction is issued. As a result, the RSA does not issue the memory access instruction A LOAD1 after the memory access instruction B LOAD2 (BBM) which is the barrier instruction until the processing of the branch instruction JMP1 C (BBM) before the memory access instruction B LOAD2 (BBM) which is the barrier instruction appended with the BBM attribute flag is completed. As a result, the memory access instructions A LOAD1 after the memory access instruction B LOAD2 (BBM) which is the barrier instruction is not speculatively executed to overtake the branch instruction JMP1 C before the memory access instruction which is the barrier instruction.

<Memory Barrier to Memory Access (MBM)>

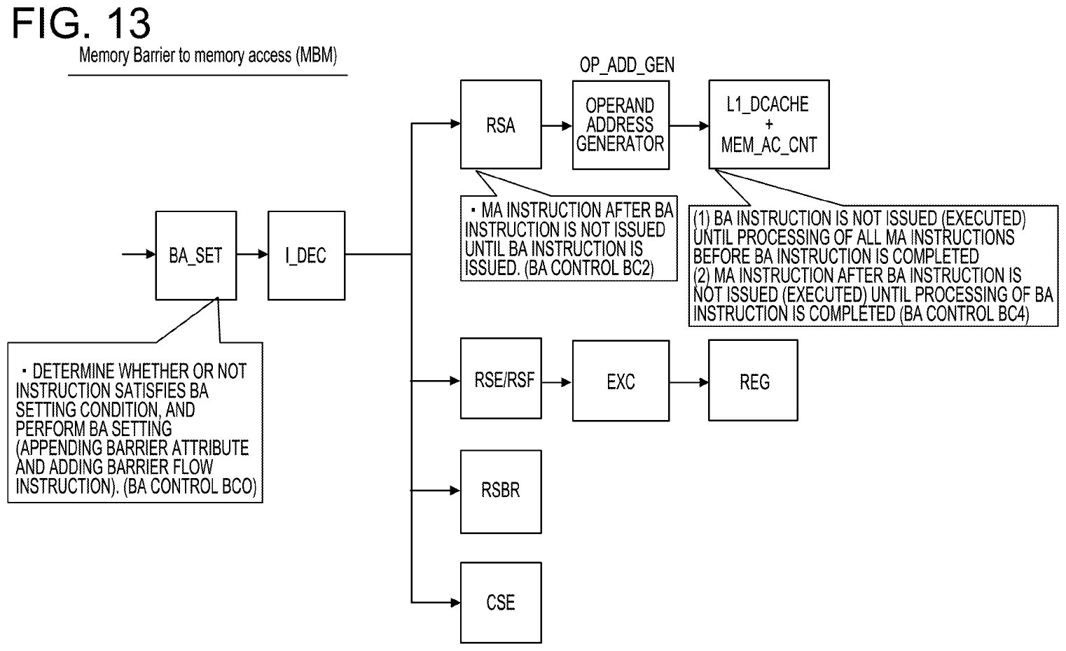

FIG. 13 is a view illustrating an outline of the order guarantee control (barrier control) in the processor related to a barrier instruction of the BBM attribute. First, like the barrier instruction with the BBM attribute in FIG. 6, the barrier setting circuit BA_SET determines whether or not the fetch instruction input from the instruction buffer corresponds to the barrier setting condition of MBM. When it is determined that the fetch instruction corresponds to the barrier setting condition of MBM, the barrier setting circuit BA_SET performs barrier setting (barrier control BA0). In the barrier setting, as described above, a barrier attribute flag is appended to the fetch instruction corresponding to the barrier setting condition. When the barrier attribute flag-appended instruction is a memory access instruction, the barrier setting circuit outputs the barrier attribute flag-appended memory access instruction (barrier instruction for executing the memory access) as it is. When the barrier attribute flag-appended instruction is an instruction other than the memory access instruction, the barrier setting circuit adds and outputs a barrier flow instruction (barrier instruction for barrier control) after the barrier attribute flag-appended instruction. Then, the RSA and the memory access control circuit MEM_AC_CNT perform the following barrier control on the barrier instruction for executing the memory access and the barrier instruction for barrier control.

In the case of the MBM attribute, the processor performs the order guarantee control to guarantee that a memory access instruction after the barrier instructions (that is, the barrier attribute flag-appended memory access instruction and the barrier flow instruction) subjected to the barrier control is not speculatively executed to overtake a memory access instruction before the instruction appended with the flag.

The barrier attribute flag-appended instruction is substantially equivalent to a barrier attribute flag-appended memory access instruction (barrier instruction for executing memory access) and a barrier flow instruction (barrier instruction for barrier control) as a barrier control target. This is because these barrier instructions are queued in the RSA and executed by the memory access control circuit. Since barrier attribute flag-appended instructions other than the memory access instruction are not necessarily queued in the RSA, the barrier attribute flag-appended instruction are not subjected to barrier control, but the added barrier flow instruction is instead subjected to barrier control in, for example, the RSA. The barrier attribute flag-appended memory access instruction (barrier instruction for executing memory access) and the barrier flow instruction (barrier instruction for barrier control) as a barrier control target will be hereinafter referred to as a barrier control target barrier instruction.

In the meantime, for the order guarantee control, when a barrier instruction (a barrier attribute-appended memory access instruction or a barrier flow instruction) is included in an execution instruction input from the instruction decoder I_DEC, the RSA firstly does not issue a memory access instruction after the barrier instruction (the barrier attribute-appended memory access instruction or the barrier flow instruction) until the barrier instruction (the barrier attribute-appended memory access instruction or the barrier flow instruction) is issued (BC2). However, the barrier instruction may be issued to overtake a memory access instruction before the barrier instruction.

By performing the issuance control to guarantee that the RSA does not issue a memory access instruction after the barrier instruction until the barrier instruction is issued (BC2), the barrier instruction and the subsequent memory access instruction are queued in an in-order in the fetch port queue FP_QUE of the memory access control circuit MA_AC_CNT.

Secondly, the memory access control circuit manages the memory access instruction notified from the RSA in a fetch port queue where the processing of the memory access instruction can be completed in the order of programs. That is, (1) the fetch port queue FP_QUE of the memory access control circuit MEM_AC_CNT does not issue (and execute) the barrier instruction (the barrier attribute-appended memory access instruction or the barrier flow instruction) (that is, does not cause the memory access control circuit to perform processing) until the processing of all of the memory access instructions before the barrier instruction (the barrier attribute-appended memory access instruction or the barrier flow instruction) is completed. In addition, (2) the fetch port queue does not issue (and execute) a memory access instruction after the barrier instruction (the barrier attribute-appended memory access instruction or the barrier flow instruction) until the processing of the barrier instruction (the barrier attribute-appended memory access instruction or the barrier flow instruction) is completed. The items (1) and (2) are the barrier control BC4.

As a result, the fetch port queue does not issue (and execute) the barrier instruction (the barrier attribute-appended memory access instruction or the barrier flow instruction) and the subsequent memory access instruction until the processing of the memory access instruction before the barrier instruction (the barrier attribute-appended memory access instruction or the barrier flow instruction) is completed.

The processor implements the above-described order guarantee control by a combination of the items (1) and (2) of the barrier control BC4 of the fetch port queue and the “barrier control BC2 which does not issue the memory access instruction after the barrier instruction until the barrier instruction is issued” by the RSA. That is, the order guarantee control is a control to guarantee that “a memory access instruction after an instruction appended with the barrier attribute flag MBM (that is, the barrier attribute flag-appended memory access instruction and the barrier flow instruction) is not speculatively executed to overtake the memory access instruction before the instruction appended with the flag.”

In the case of the barrier instruction having the BBM barrier attribute described above, since the RSA issues the barrier instruction after completion of processing of the branch instruction before the barrier instruction, there is no need to perform the barrier control BC4 in the fetch port queue in the memory access control circuit.

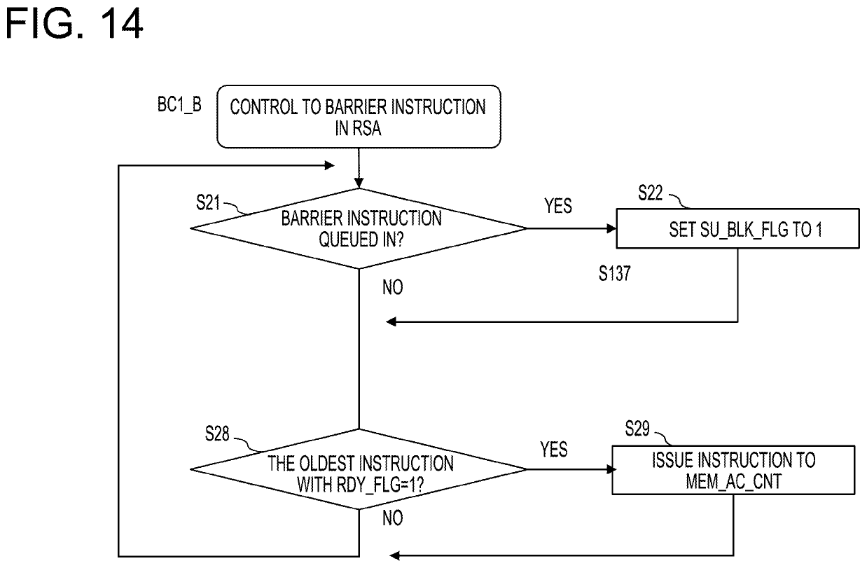

FIG. 14 is a flowchart of barrier control BC1_B for the barrier instruction in the RSA. In the barrier control BC1_B, steps S23 to S27 are deleted from the barrier control BC1 in FIG. 7. That is, when the barrier instruction is queued (“YES” in S21), the RSA sets the storage unit block flag SU_BLK_flg of the barrier instruction to “1” (S22). Then, the RSA issues the oldest instruction whose ready flag RDY_flg is “1,” among the queued instructions, to the memory access control circuit MEM_AC_CNT.

Hereinafter, the barrier control in the RSA will be described by way of Example_3. In the barrier control, in addition to the flowchart of the barrier control for the barrier instruction in FIG. 14, reference is also made to the flowchart of the barrier control BC2 for the instructions other than the barrier instruction in the RSA illustrated in FIG. 8.

### Example_3: Example in which an Instruction Appended with the MBM Attribute Flag is a Memory Access Instruction

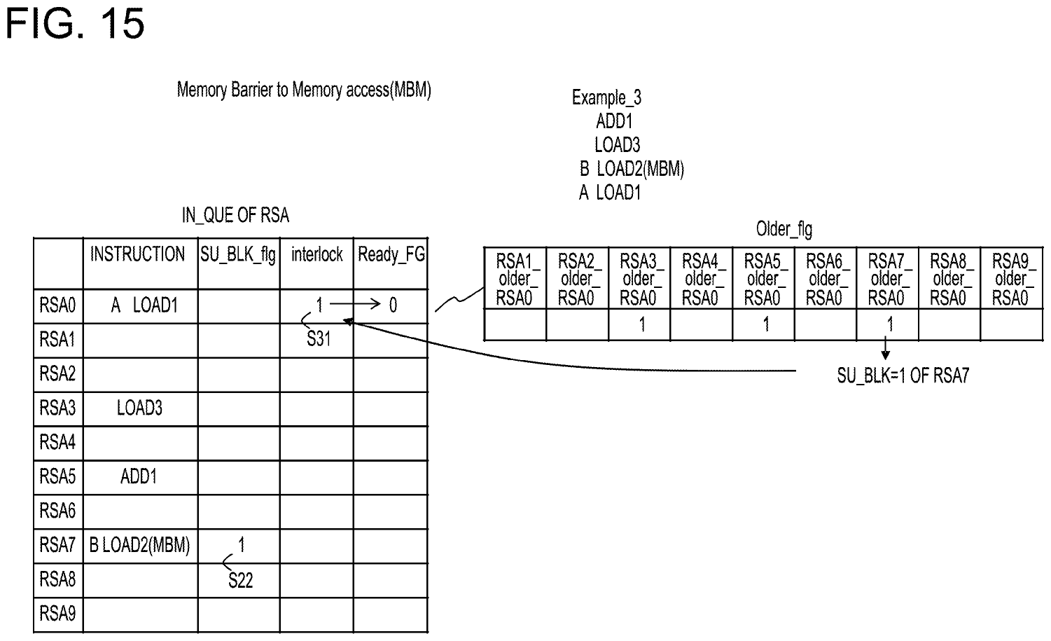

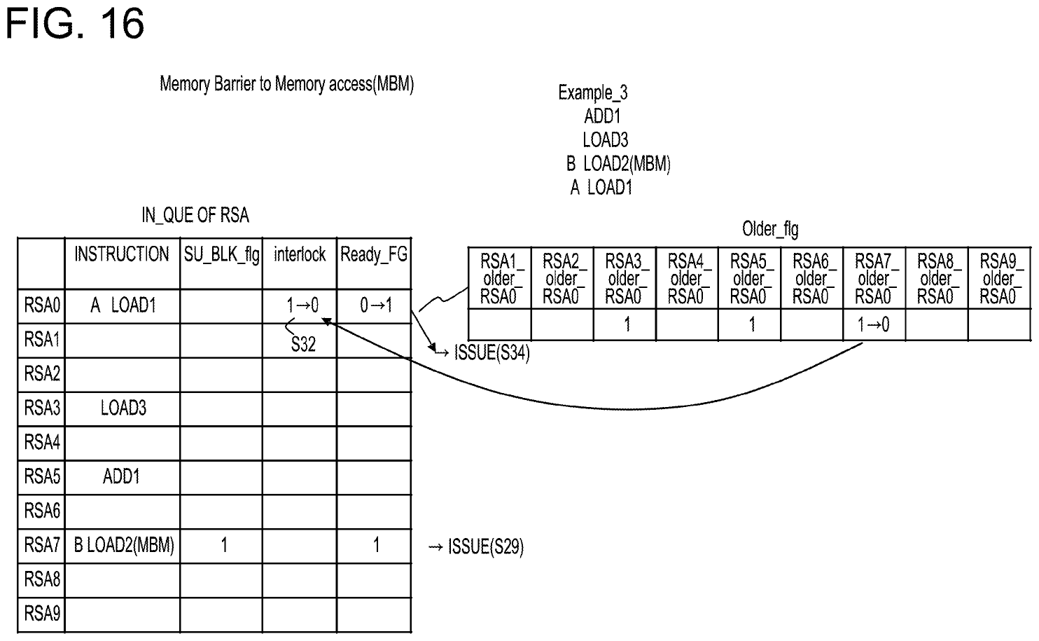

FIGS. 15 and 16 are views illustrating an example of barrier control in the RSA for Example_3 in a case where an instruction appended with the MBM attribute flag is a memory access instruction. Example_3 illustrated in FIG. 15 is an instruction string including an addition instruction ADD1 and three memory access instructions LOAD3, B LOAD2 (MBM), and A LOAD1. The instruction string is queued in an in-order from the instruction decoder into the RSA. The RSA issues the instruction string to the memory access control circuit in an out-of-order between the memory access instructions LOAD3 and B LOAD2 (BMB) and in an in-order between B LOAD2 (BMB) and A LOAD1.

When the memory access instruction B_LOAD2 (MBM) which is a barrier instruction is queued in the input queue IN_QUE of the RSA in FIG. 15 (“YES” in S21), the RSA generates an entry in the memory access instruction B_LOAD2 (MBM) with the storage unit block flag SU_BLK_flg=1.

Meanwhile, the RSA determines whether or not an instruction having its own order older than (in front of) the memory access instruction A LOAD1 after the memory access instruction B_LOAD2 (MBM) which is the barrier instruction and having SU_BLK_flg=1 exists in the input queue IN_QUE (S30 in FIG. 8). In the example of FIG. 15, since the memory access instruction B_LOAD2 (MBM) having an order older than the memory access instruction A LOAD1 and having SU_BLK_flg=1 exists in the input queue IN_QUE, the determination result is true (“YES” in S30). Accordingly, the RSA sets the interlock of the memory access instruction A LOAD1 to Interlock=1 (S31). By the Interlock=1, the ready flag becomes RDY_flg=0, and the memory access instruction A LOAD1 may not be issued from the RSA.

Next, a transition is made to the input queue state of FIG. 16. As illustrated in FIG. 14, since no interlock is applied to the memory access instruction B LOAD2 (MBM) which is the barrier instruction, the ready flag RDY_flg becomes “1” when the memory access instruction B LOAD2 (MBM) can solve the problem of the read-after-write, and the memory access instruction B LOAD2 (MBM) issued from the RSA when the memory access instruction B LOAD2 (MBM) becomes the oldest instruction (“YES” in S28 and S29 of FIG. 14). By the issuance, the memory access instruction B LOAD2 (BMB) is erased from the RSA and is reflected in the older flag of each entry. As a result, the interlock of the memory access instruction A LOAD1 is released to “0” (S32 in FIG. 8), and the ready flag becomes the issue ready state “1.” Thereafter, the RSA issues the memory access instruction A LOAD1 (S34 in FIG. 8).

With the above barrier controls BC1_B and BC2, the memory access instruction B LOAD2 (BMB), which is the barrier instruction, and the subsequent memory access instruction A LOAD1 are queued in an in-order from the RSA into the fetch port queue FP_QUE in the SU access control circuit.

With the above barrier controls, the RSA does not issue a memory access instruction after the barrier instruction until the barrier instruction is issued. As a result, the RSA does not issue the memory access instruction A LOAD1 after the MBM attribute flag-appended memory access instruction (the barrier instruction for executing memory access) B LOAD2 (BMB) until the MBM attribute flag-appended memory access instruction is issued. Therefore, B LOAD2 (BMB) and A LOAD1 are issued in an in-order from the RSA into the fetch port queue FP_QUE.

Secondly, the memory access control circuit MEM_AC_CNT performs completion processing in an in-order for all the memory access instructions before the MBM attribute flag-appended memory access instruction (barrier instruction), the barrier instruction, and the subsequent memory access instruction.

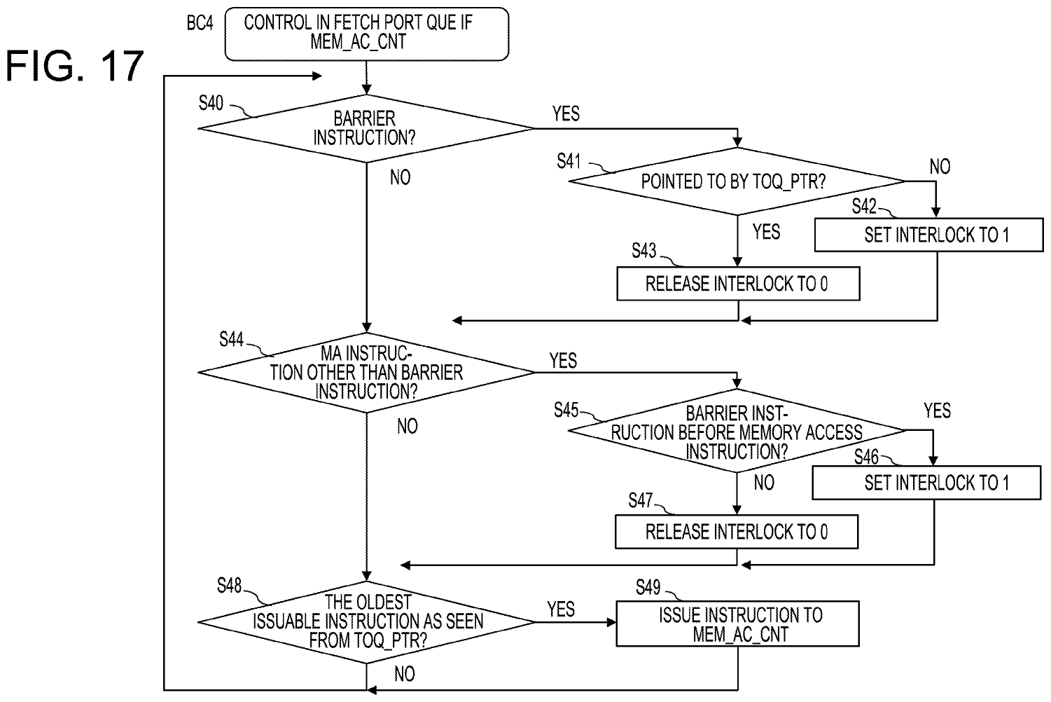

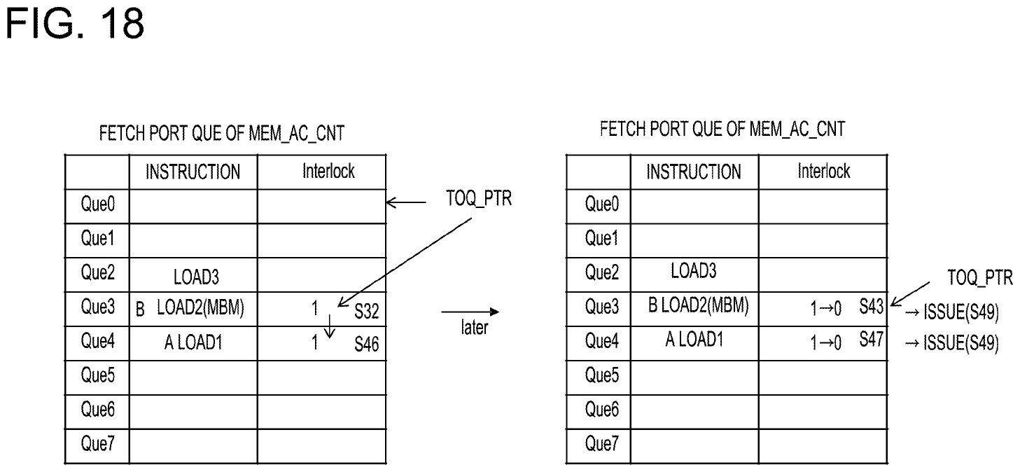

FIG. 17 is a flowchart illustrating an example of a control in the queue FP_QUE of the fetch port of the memory access control circuit. FIG. 18 is a view illustrating an example of the queue FP_QUE of the fetch port. FIG. 18 illustrates a state (the left side) in which the instruction of Example_3 is queued from the RSA and then a state (the right side) in which the instruction is issued from the fetch port.

The input queue of the memory access control circuit MEM_AC_CNT is called a fetch port, and queue numbers Que0 to Que7 are cyclically allocated to instructions in the order of programs (in-order). The cyclic allocation means that the queue number Que0 is allocated next to the queue number Que7. Therefore, a top-of-queue pointer TOQ_PTR indicating which entry of the queue is the oldest entry is managed.

The rule of issuance from the fetch port queue to the memory access control circuit is to issue an instruction of the oldest entry that can be issued. Therefore, an instruction of the issuable entry first found after looking backward from the entry of TOQ_PTR is issued. The issuable state refers to a state in which a memory address of a memory access instruction issued from the RSA is known and is not interlocked. The memory address is generated, for example, by an arithmetic operation by the operand address generation circuit.

Therefore, since an instruction is issued in an out-of-order from the RSA, it cannot be said that the memory access instruction is necessarily completed in the order of queue numbers in the fetch port queue. Therefore, the barrier control BC4 for the order guarantee to be described below is performed.

A memory access instruction requesting memory access is queued in the fetch port of the memory access control circuit. The memory access instruction has a short latency when a cache hit occurs in the L1 data cache, but it has a long latency when a cache miss occurs and an access to the main memory occurs. In addition, the memory access instruction may be aborted during an access control by the memory access control circuit and issued again from the fetch port. The memory access instruction issued from the fetch port disappears from the fetch port when the memory access processing is completed, a data response is received, and the top-of-queue pointer TOQ_PTR points to the memory access instruction. As a result, the fetch port allocates the entry of the memory access instruction in an in-order, and opens the entry in an in-order.

On the left side of FIG. 18, entries of LOAD3, B LOAD2 (MBM), and A LOAD1 in the instruction string of Example_3 are generated in Que2 to 4 of the fetch port queue. As described above, the RSA controls the issuance of the barrier instruction B LOAD2 (MBM) and the subsequent memory access instruction A LOAD1 in an in-order, but it may issue in an out-of-order between the barrier instruction B LOAD2 (MBM) and the barrier access instruction LOAD3 before the barrier instruction B LOAD2 (MBM). However, the fetch port interlocks the barrier instruction B LOAD2 (MBM) and the subsequent memory access instruction A LOAD1 according to the following control, so as to suppress the issuance until the memory access instruction LOAD3 before the barrier instruction B LOAD2 (MBM) is queued in the fetch port.

That is, as illustrated in FIG. 17, when the memory access instruction B LOAD2 (MBM) is a barrier instruction (“YES” in S40) and is not pointed to by the top-of-queue pointer TOQ_PTR (“NO” in S41), the fetch port queue sets the interlock to “1” and inhibits the issuance until all the memory access instructions before the memory access instruction BLOAD2 (BMB) are issued (S42).

At the same time, when the memory access instruction is an instruction after the barrier instruction (“YES” in S44) and the barrier instruction of the MBM attribute before the memory access instruction is entered in the fetch port queue (“YES” in S45), the fetch port queue sets the interlock to “1” and inhibits the issuance until the barrier instruction of the MBM attribute is issued.

Meanwhile, the fetch port queues releases the interlock of the barrier instruction to “0” (S43) when the barrier instruction B LOAD2 (MBM) is pointed to by TOQ_PTR (“YES” in S41), and releases the interlock of the memory access instruction A LOAD1 after the barrier instruction to “0” (S47) when the barrier instruction B LOAD2 (MBM) of the MBM attribute disappears before the memory access instruction A LOAD1 (“NO” in S45).

Then, the fetch port issues the oldest (earliest) issuable instruction as seen from TOQ_PTR (“YES” in S48) to the memory access control circuit (S49).

According to the control of the fetch port, the barrier instruction B LOAD2 (MBM) and the subsequent memory access instruction A LOAD1 stay in the fetch port until the memory access instruction LOAD3 before the barrier instruction is queued, issued, and completed in the fetch port and disappears from the fetch part. The state on the left side of FIG. 18 represents a state when the memory access instruction LOAD3 is queued.

Next, on the right side after the passage of time from the left side of FIG. 18, when the memory access instruction LOAD3 before the memory access instruction B LOAD2 (MBM) which is the barrier instruction of Que3 is issued and completed, the top-of-queue pointer TOQ_PTR points to the memory access instruction B LOAD2 (MBM) (“YES” in S41). Then, the fetch port queue releases the interlock of the memory access instruction B LOAD2 (MBM) to “0” (S43). As a result, the memory access instruction B LOAD2 (MBM) is issued to the memory access control circuit (“YES” in S48 and S49).

When the barrier instruction of the MBM attribute is issued and thereafter completed and disappears from the fetch port queue, the interlock of the memory access instruction A LOAD1 of Que4 is released to “0” (“NO” in S45 and S47). Thereafter, the memory access instruction A LOAD1 is issued from the fetch port queue (S49) and thereafter is completed. The memory access instruction after the barrier instruction is issued and executed in an out-of-order after the barrier instruction is completed.

<In Case where an Instruction Appended with the MBM Attribute Flag is an Instruction Other than the Memory Access Instruction>

In a case where an instruction appended with the MBM attribute flag is an instruction other than the memory access instruction, the barrier setting circuit adds a barrier flow instruction (barrier instruction for barrier control) after the MBM attribute flag-appended instruction, the instruction decoder allocates the barrier flow instruction to the RSA. Then, according to the barrier controls BC1_B and BC2 in the RSA and the barrier control BC4 in the fetch port of the memory access control circuit, the order guarantee of the memory access instruction before the barrier flow instruction and the memory access instruction after the barrier flow instruction will be complied.

Specifically, the barrier instruction B LOAD2 (MBM) in FIGS. 15, 16 and 18 is replaced with the barrier flow instruction BA_FLW. In the barrier control, the same control as that performed for the barrier instruction B LOAD2 (MBM) is performed for the barrier flow instruction. Therefore, explanation of a specific example where an instruction appended with a barrier attribute is an instruction other than the memory access instruction will be omitted.

As described above, according to the barrier control in the RSA and the barrier control in the fetch port of the memory access control circuit, the order guarantee for the barrier instruction of the MBM attribute is complied. As a result, the processor prevents the memory access instruction A LOAD1 after the memory access instruction B LOAD2 (MBM), which is a barrier instruction, from being speculatively executed until the barrier instruction B LOAD2 (MBM) and the memory access instruction LOAD3 before the barrier instruction are completed.

<All Barrier to Memory Access (ABM)>

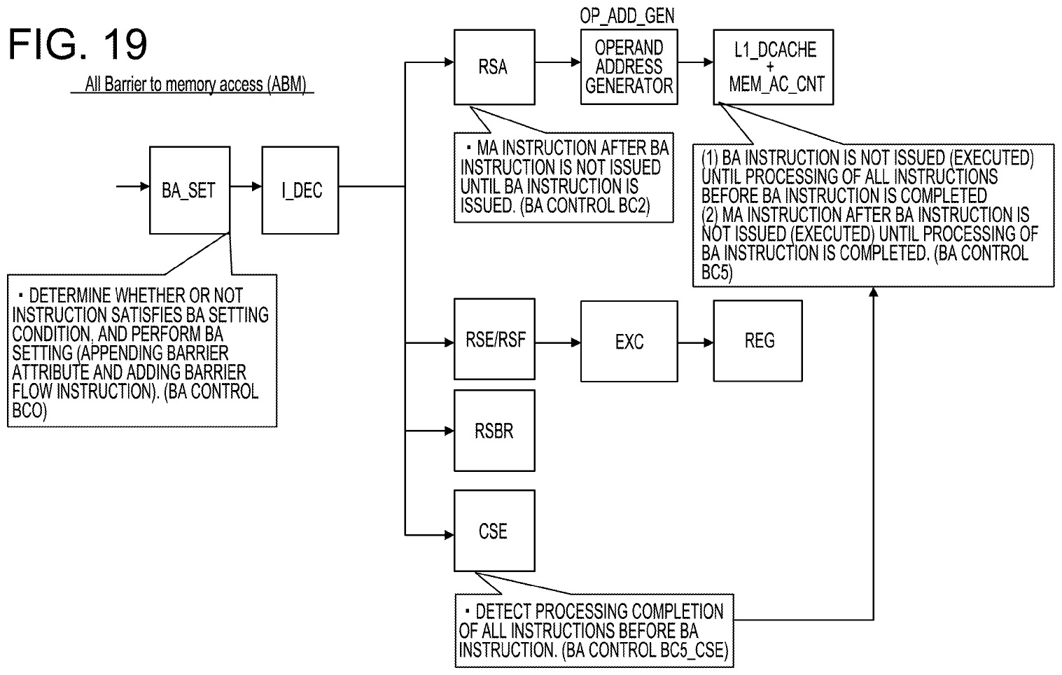

FIG. 19 is a view illustrating an outline of the order guarantee control (barrier control) in the processor related to the barrier instruction of the ABM attribute. The control BC0 of the barrier setting circuit BA_SET is the same as the case of the MBM attribute.

In the case of the ABM attribute, the processor performs the order guarantee control to guarantee that the memory access instruction after the instruction appended with the barrier attribute flag ABM is not speculatively executed to overtake all the instructions (being not limited to the memory access instruction as in MBM) before the barrier attribute flag-appended instruction.

For the order guarantee control, when a barrier instruction (a barrier attribute-appended memory access instruction or a barrier flow instruction) is included in an execution instruction input from the instruction decoder I_DEC, the RSA firstly does not issue a memory access instruction after the barrier instruction until the barrier instruction is issued (BC2). Therefore, the memory access instruction after the barrier instruction (the barrier attribute-appended memory access instruction or the barrier flow instruction) is issued to the memory access control circuit after the barrier instruction.

By performing the issuance control to guarantee that the RSA does not issue a memory access instruction after the barrier instruction until the barrier instruction is issued (BC2), the barrier instruction and the memory access instruction after the barrier instruction are queued in an in-order in the fetch port queue FP_QUE of the memory access control circuit MA_AC_CNT. The control BC2 is also the same as the control of the RSA of the MBM attribute.

Secondly, the memory access control circuit manages the memory access instruction notified from the RSA in a fetch port queue where the processing of the memory access instruction can be completed in the order of programs. (1) The fetch port queue FP_QUE of the memory access control circuit MEM_AC_CNT does not issue the barrier instruction (the barrier attribute-appended memory access instruction or the barrier flow instruction) until the processing of all of the instructions before the barrier instruction (the barrier attribute-appended memory access instruction or the barrier flow instruction) is completed. In addition, (2) the fetch port queue does not issue a memory access instruction after the barrier instruction (the barrier attribute-appended memory access instruction or the barrier flow instruction) until the processing of the barrier instruction (the barrier attribute-appended memory access instruction or the barrier flow instruction) is completed (barrier control BC5).

Thirdly, the completion of processing of all of the instructions before the barrier instruction (the barrier attribute-appended memory access instruction or the barrier flow instruction) may be detected based on a determination as to whether or not the IID of the top-of-queue pointer of the input queue of CSE matches the IID of the barrier instruction (the barrier attribute-appended memory access instruction or the barrier flow instruction). In the detection processing, the fetch port detects that all the instructions prior before the barrier instruction (the barrier attribute-appended memory access instruction or the barrier flow instruction) have been processed, and performs a control ((1) of BC5) to issue the barrier instruction (the barrier attribute-appended memory access instruction or the barrier flow instruction).

As a result, the fetch port queue does not issue the barrier instruction (the barrier attribute-appended memory access instruction or the barrier flow instruction) and the subsequent memory access instruction until the processing of all the instructions before the barrier instruction (the barrier attribute-appended memory access instruction or the barrier flow instruction) is completed.

Hereinafter, the barrier control in the RSA will be described by way of Example_4. In the barrier control, in addition to the flowchart of the barrier control for the barrier instruction in FIG. 14, reference is also made to the flowchart of the barrier control BC2 for the instructions other than the barrier instruction in the RSA illustrated in FIG. 8.

### Example_4: In Case where an Instruction Appended with a Barrier Attribute Flag is a Memory Access Instruction

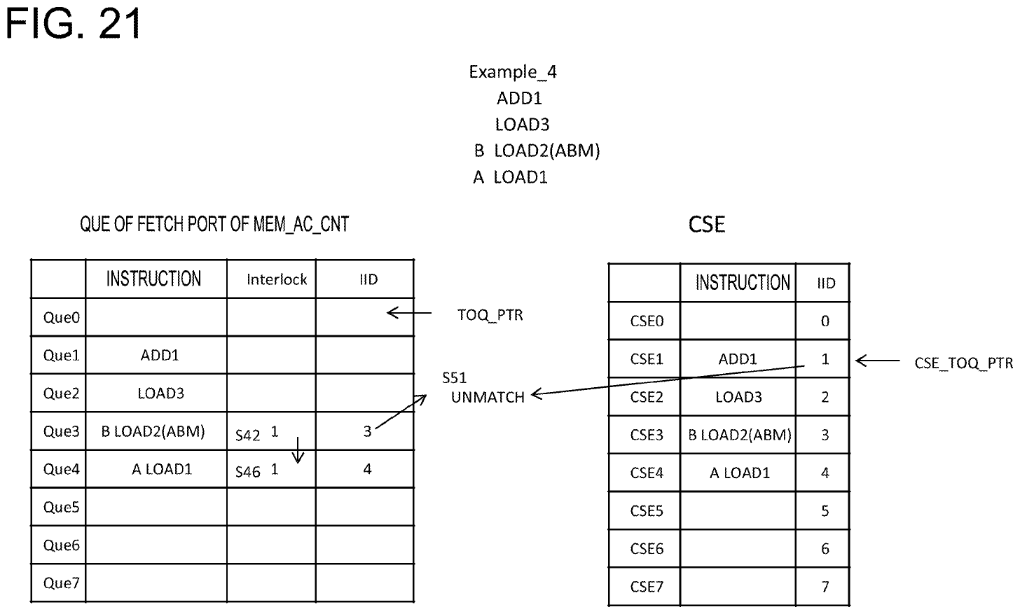

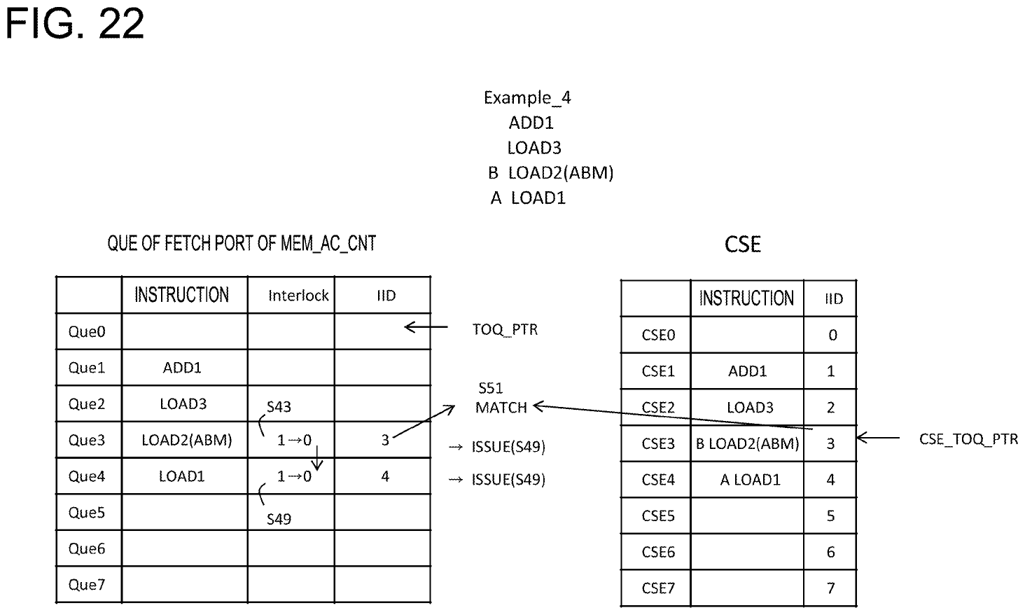

As illustrated in FIGS. 21 and 22, the instruction string of Example_4 is the same as the instruction string of Example_3 illustrated in FIGS. 15 and 16.

Firstly, the barrier controls BC1_B and BC2 by the RSA are the same as the barrier controls BC1_B and BC2 illustrated in FIGS. 15 and 16 for the barrier attribute MBM. Secondly, the barrier control BC5 in the fetch port of the memory access control circuit is as follows.

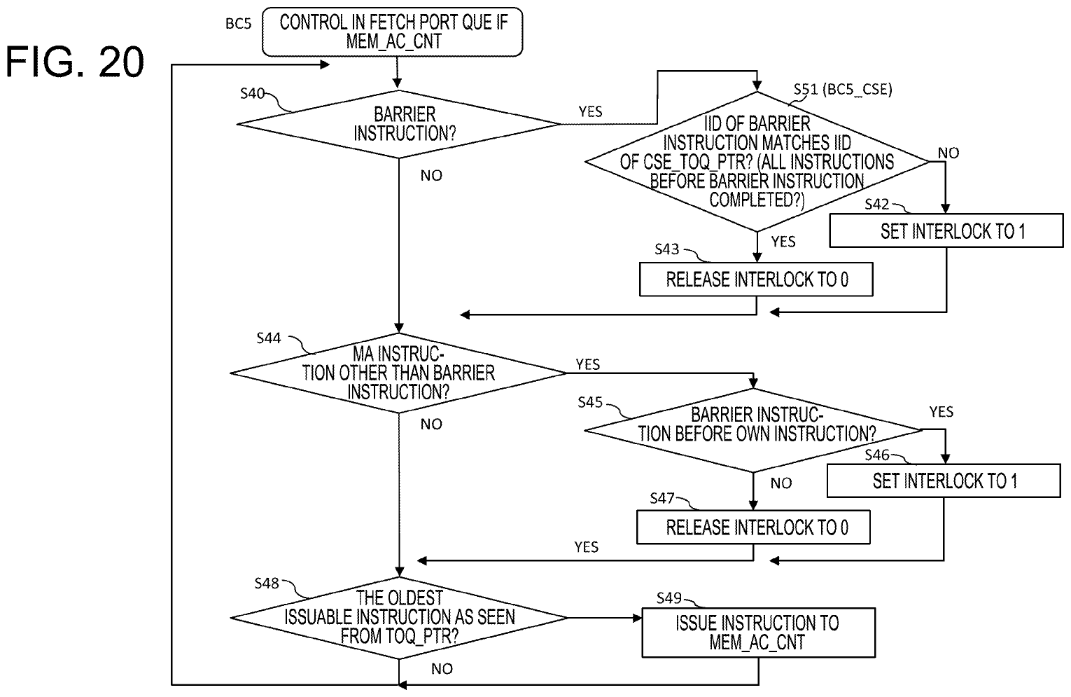

FIG. 20 is a flowchart of the barrier control BC5 in the fetch port of the memory access control circuit. The steps S40 and S42 to S49 of the flowchart of FIG. 20 are the same as the steps S40 and S42 to S49 of FIG. 17. However, the step S51 of the flowchart of FIG. 20 is different from the step S41 of FIG. 17. Specifically, the fetch port determines whether or not an instruction ID (IID) pointed to by the top-of-queue pointer CSE_TOQ_PTR of the CSE matches the IID of the barrier instruction (the barrier attribute-appended memory access instruction or the barrier flow instruction), and determines whether or not the processing of all the instructions before the barrier instruction has been completed (S51).

According to the flowchart of FIG. 20, when an instruction having an entry generated in the queue is a barrier instruction (S40), and when the instruction ID (IID) pointed to by the top-of-queue pointer CSE_TOQ_PTR of the CSE does not match the IID of the barrier instruction (“NO” in S51), the fetch port sets the interlock of the barrier instruction to “1” to prohibit the issuance. Meanwhile, when the instruction ID (IID) pointed to by the top-of-queue pointer CSE_TOQ_PTR of the CSE matches the IID of the barrier instruction (“YES” in S51), the fetch port releases the interlock of the barrier instruction to “0” to permit the issuance (S43). Thereafter, when the barrier instruction becomes the oldest issuable instruction, the barrier instruction is issued and executed by the memory access control circuit.

Meanwhile, when the instruction in the queue of the fetch port is a memory access instruction other than the barrier instruction (S44), and when there is a barrier instruction before the memory access instruction (“YES” in S45), the interlock is set to “1” (S46). When the barrier instruction disappears (“NO” in S45), the interlock is released to “0” (S47).

FIGS. 21 and 22 are views for explaining the barrier control BC5 in the fetch port of the memory access control circuit for Example_4. FIGS. 21 and 22 illustrate a queue of the fetch port of the memory access control circuit and a queue of the CSE.

In the CSE queue, all instructions of an instruction string are entered, IID is allocated to all the instructions, and the top-of-queue pointer CSE_TOQ_PTR is shifted every time the processing of all the instructions is completed. Meanwhile, in the fetch port of the memory access control circuit, memory access instructions in an instruction string are entered, and respective interlocks Interlock and IIDs are held. Therefore, by checking an IID pointed to by the top-of-queue pointer CSE_TOQ_PTR of the CSE, it is possible to know to which instruction the completion processing has been performed.

In the state of FIG. 21, the top-of-queue pointer CSE_TOQ_PTR of the CSE points to ADD1, and IID=1 of ADD1 does not match IID=3 of the barrier instruction B LOAD2 (ABM) in the fetch port of the memory access control circuit (“NO” in S51). Therefore, the fetch port sets the interlock of the barrier instruction to “1” to prohibit the issuance (S42). Along with the operation, since the barrier instruction B LOAD2 (ABM) exists before the instruction A LOAD1 (“YES” in S45), the interlock of the instruction A LOAD1 is also set to “1” to prohibit the issuance (S47).

Next, in the state of FIG. 22, the top-of-queue pointer CSE_TOQ_PTR of the CSE points to the barrier instruction B LOAD2 (ABM), and its IID=3 matches the IID=3 of the barrier instruction B LOAD2 (ABM) in the fetch port (“YES” in S51). Therefore, the fetch port releases the interlock of the barrier instruction to “0” to permit the issuance (S43). Thereafter, the barrier instruction is issued (S49). Along with this, since the barrier instruction B LOAD2 (ABM) does not exist before the instruction A LOAD1 (“NO” in S45), the interlock of the instruction A_LOAD1 is also released to “0” (S47) to permit the issuance and thereafter the instruction A_LOAD1 is issued (S49).

<In Case where an Instruction Appended with a Barrier Attribute is an Instruction Other than the Memory Access Instruction>

In a case where an instruction appended with the barrier attribute is an instruction other than the memory access instruction, the barrier setting circuit additionally issues a barrier flow instruction after the barrier attribute-appended instruction, and the instruction decoder allocates the barrier flow instruction to the RSA. As described above, the barrier flow instruction is one of the barrier instructions and is subjected to the barrier control in the RSA or the memory access control circuit. That is, according to the barrier controls BC1_B and BC2 in the RSA and the barrier control BC5 in the fetch port of the memory access control circuit, the order guarantee of the barrier flow instruction and the subsequent memory access instruction is complied.

Specifically, the barrier instruction B LOAD2 (MBM) in FIGS. 21 and 22 is replaced with the barrier flow instruction BA_FLW. Then, in the barrier control, the same control as that performed for the barrier instruction B LOAD2 (MBM) is performed for the barrier flow instruction. Therefore, explanation of a specific example where an instruction appended with a barrier attribute is an instruction other than the memory access instruction will be omitted.

As described above, according to the barrier control in the RSA and the barrier control in the fetch port of the memory access control circuit, the order guarantee for the barrier instruction of the ABM attribute is complied. As a result, it is possible to prevent the memory access instruction A LOAD1 after the memory access instruction B LOAD2 (MBM) from being speculatively executed until the processing of all instructions before the instruction B LOAD2 (MBM) is completed.

<All Barrier to All (ABA)>

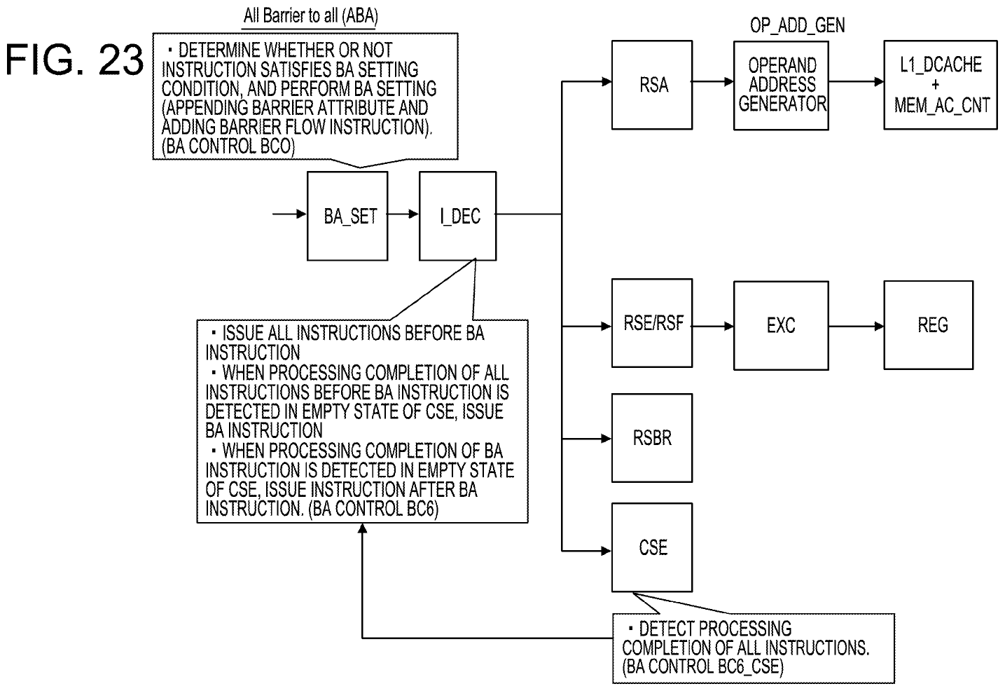

FIG. 23 is a view illustrating an outline of the order guarantee control (barrier control) in the processor related to an instruction appended with the barrier attribute ABM. In the case of the barrier attribute ABA, it is not permitted to overtake all instructions without being limited to memory access instructions. Therefore, a barrier control BC6 is performed by the instruction decoder to issue all the instructions.

Since all the instructions are processed by the instruction decoder, no barrier flow instruction is added to the instruction appended with the barrier attribute ABA. Therefore, in the case of the barrier attribute ABA, the barrier instruction is only the instruction appended with the barrier attribute ABA.

Further, the instruction decoder determines that the processing of all the instructions before the barrier instruction has been completed and that the processing of the barrier instruction has been completed, based on an IID pointed to by the top-of-queue pointer of the CSE that completes the processing of all instructions (BC6_CSE).

As a result, the processor performs the order guarantee control to guarantee that all instructions after the barrier instruction appended with the barrier attribute ABA are not speculatively executed to overtake all the instructions before the barrier instruction.

First, the barrier setting circuit generates a barrier instruction (instruction appended with the barrier attribute ABA) (BC0). Next, for the order guarantee control, when the barrier instruction is received from the barrier setting circuit BA_SET, the instruction decoder I_DEC (1) issues all instructions before the barrier instruction in an in-order to the corresponding RS and CSE, (2) issues the barrier instruction when the completion of processing of all instructions before the barrier instruction is detected by the fact that the CSE entered an empty state, and (3) issues instructions after the barrier instruction in an in-order when the completion of processing of the barrier instruction is detected by the fact that the CSE entered an empty state (BC5). The instruction decoder I_DEC detects the empty state of the CSE (BC6_CSE) based on a report of the completion of instruction processing from the CSE.

In this way, in the case of the barrier instruction appended with the barrier attribute ABA, all the instructions before the barrier instruction are executed and the completion of processing thereof is checked. Then, the barrier instruction is executed and the completion of processing thereof is checked. After that, all the instructions after the barrier instruction are executed. Therefore, the barrier control with the strictest regulation for the order guarantee of instruction execution is performed. In this case, speculative execution for all instructions after the barrier instruction is not permitted. When the speculative execution of an instruction causes the processor vulnerability, the speculative execution may be prevented by appending the barrier attribute ABA to the instruction.

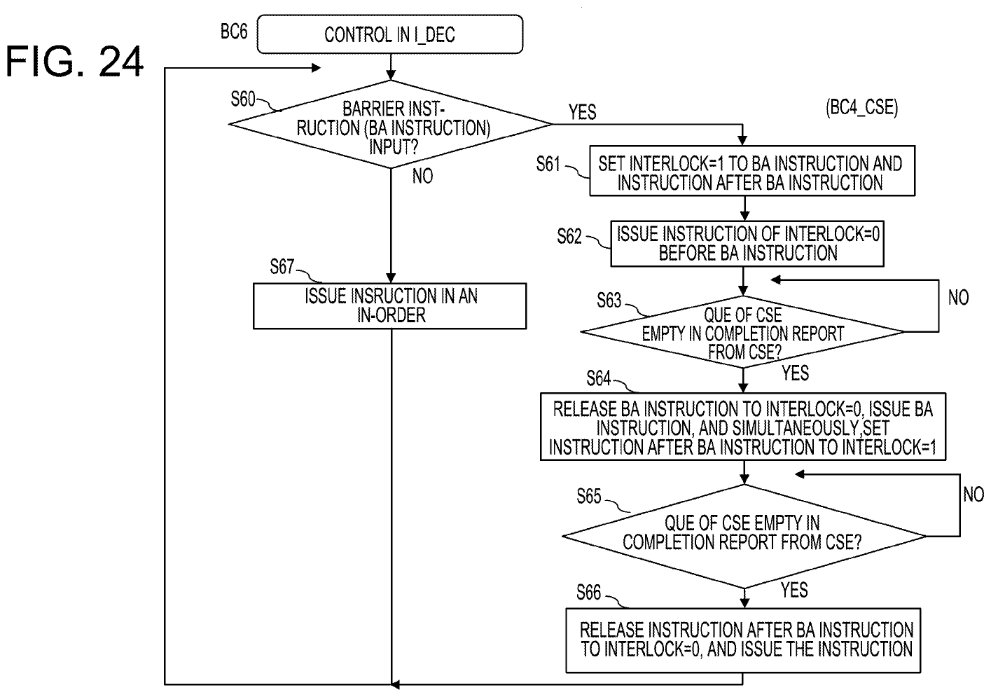

FIG. 24 is a flowchart illustrating the barrier control BC6 for the barrier instruction (BA instruction) and instructions before and after the barrier instruction in the instruction decoder. When a barrier instruction is input (“YES” in S60), the instruction decoder sets the interlocks of the barrier instruction and an instruction after the barrier instruction to “1” to prohibit the issuance (S61). Then, the instruction decoder issues an instruction having an interlock of “0” before the barrier instruction (S62).

Subsequently, the instruction decoder manages the number of instructions remaining in the queue of the current CSE by an instruction processing completion notification from the CSE, and detects that the CSE is empty when the number of instructions in the CSE is zero (“YES” in S63). In response to the detection of the empty state of the CES, the instruction decoder releases the interlock of the barrier instruction to “0” and issues the barrier instruction (S64). At the same time, the instruction decoder keeps the interlock of an instruction after the barrier instruction at “1” (S64).

Subsequently, the instruction decoder manages the number of instructions in the CSE by an instruction processing completion notification from the CSE, and detects that the CSE is empty when the number of instructions in the CSE is zero (“YES” in S65). In response to the detection of the empty state of the CES, the instruction decoder releases the interlock of the instruction after the barrier instruction to “0” and issues the instruction after the barrier instruction (S66).

While the barrier instruction is not input, the instruction decoder issues the instruction in an in-order to the RS and the CSE (S67).

### Example_5

In the case of the barrier attribute ABA, when the barrier setting condition is satisfied, regardless of whether an instruction appended with the barrier attribute is a memory access instruction or an instruction other than the memory access instruction, the barrier setting circuit appends the barrier attribute to the corresponding instruction and issues the instruction to the instruction decoder. The barrier control by the RSA is not performed. In the following description, it is assumed that an instruction appended with a barrier attribute is a barrier instruction.

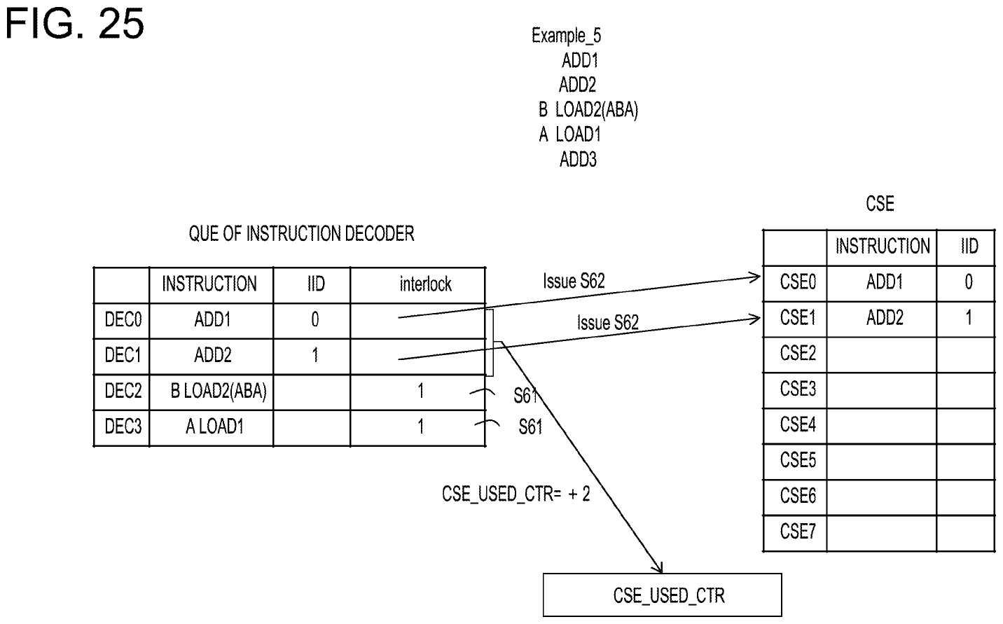

FIGS. 25, 26, and 27 are views for explaining the barrier control BC6 for an instruction string of Example_5. The barrier attribute ABA is appended to B LOAD2 of the instruction string.

In FIG. 25, it is assumed that ADD1, ADD2, B LOAD2 (ABA), and A LOAD1 of the instruction string of Example_5 have already been input in the queue of the instruction decoder. In this case, the interlocks of the barrier instruction B LOAD2 (ABA) and the subsequent instruction A LOAD1 are set to “1” (S61). Then, the instruction decoder issues the instructions ADD1 and ADD2 in an in-order to the CSE and an RS (not illustrated) (S62). In addition, the instruction decoder manages the number of instructions in the CSE with a CSE use counter CSE_USE_CTR. Since the instruction decoder issued the two instructions ADD1 and ADD2 to the CSE, the count value of the CSE use counter is “2”

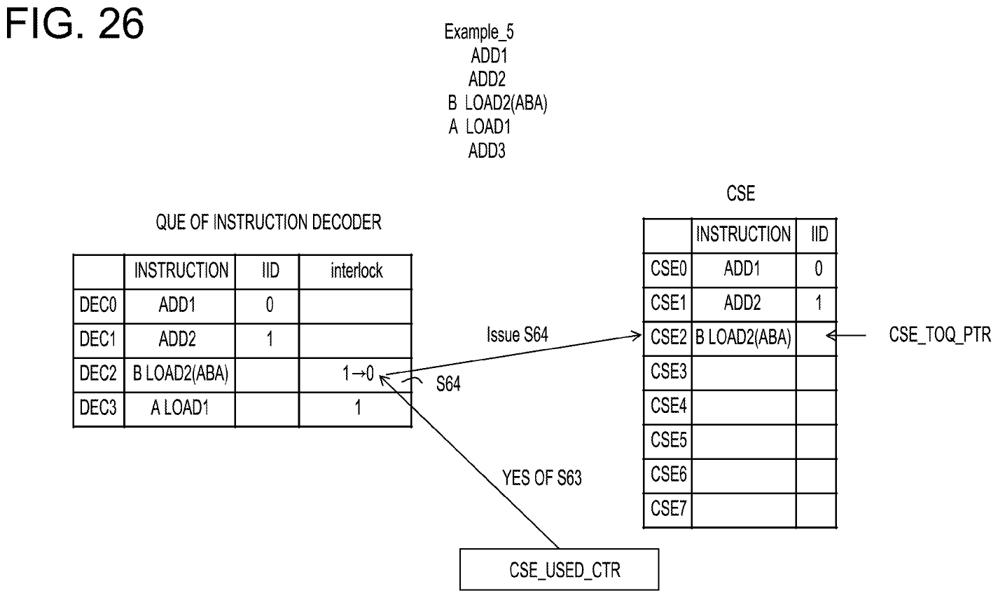

As illustrated in FIG. 26, the CSE performs completion processing of the two instructions ADD1 and ADD2, and the top-of-queue pointer CES_TOQ_PTR moves to CSE2. The count value of the CSE use counter managed by the instruction decoder becomes “0” based on a completion processing report of each of the two instructions from the CSE. Thereby, the instruction decoder detects that the CSE is in the empty state (“YES” in S63). As a result, the instruction decoder releases the interlock of the barrier instruction B LOAD2 (ABA) to “0” (S64) and then issues the barrier instruction B LOAD2 (ABA) to the CSE and the RS (not illustrated) (S64). At this time, the instruction decoder keeps the interlock of the instruction A LOAD1 after the barrier instruction to “1” (S64).

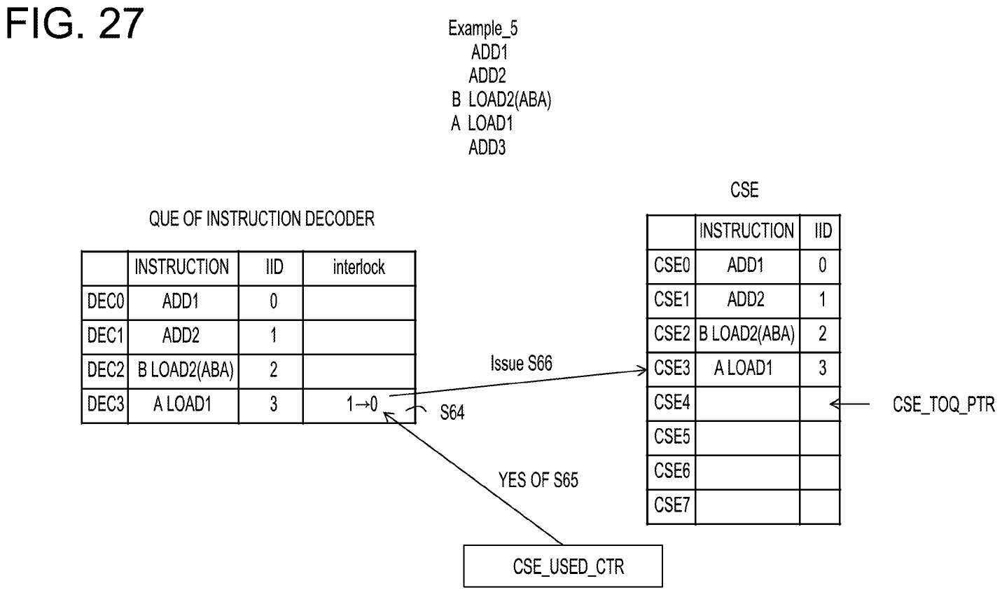

As illustrated in FIG. 27, the CSE performs completion processing of the barrier instruction B LOAD2 (ABA), and the count value of the CSE use counter managed by the instruction decoder becomes “0” based on a completion processing report of the barrier instruction from the CSE. Thereby, the instruction decoder detects that the CSE is in the empty state (“YES” in S65). As a result, the instruction decoder releases the interlock of the instruction A LOAD1 after the barrier instruction B LOAD2 (ABA) to “0” (S66) and then issues the instruction A LOAD1 to the CSE and the RS (not illustrated) (S66).

As a result, the instruction decoder becomes empty and the next fetch instruction is input in an in-order. Thereafter, in the same manner as above, the issuance of an instruction before the barrier instruction, detection of the empty state of the CSE, issuance of the barrier instruction, detection of the empty state of the CSE, and issuance of an instruction after the barrier instruction are repeated.

According to the barrier control described above, the processor complies with the order guarantee that all instructions after an instruction appended with the barrier attributes ABA (barrier instruction) are not speculatively executed to overtake all instructions before the barrier attributes ABA-appended instruction (barrier instruction).

### Example of Setting in Barrier Setting Condition Register

In the present embodiment, in order to prevent the memory access instruction described first with reference to FIG. 1 from being speculatively executed, the barrier setting condition is set in the barrier setting condition register. For example, as in the first example illustrated in FIG. 1, when it is desired to prevent a memory access instruction of a branch prediction destination from being speculatively executed before a branch instruction is determined to branch, the barrier setting condition register is set so that the barrier attribute BBM is appended to a branch instruction in the privileged mode as the barrier setting condition. In addition, when it is desired to prevent the two load instructions described after the second example from being speculatively executed, the barrier setting condition register is set so that the barrier attribute MBM is appended to a memory access instruction in the privileged mode as the barrier setting condition. When it is desired to prevent other instructions from being speculatively executed, the barrier setting condition register is set so that the barrier attribute ABM or ABA is appended to an instruction in the privileged mode as the barrier setting condition.

Since the security vulnerability of the processor varies depending on users, it is desirable that each user selects a necessary barrier attribute and sets the barrier setting condition.

In either case, for example, in an initialization process in which a user executes an application, a desired barrier setting condition is set in the barrier setting condition register or a barrier setting condition is set in the barrier condition register at a specific timing of the application.

As described above, according to the present embodiment, by setting the barrier setting condition in the barrier setting register to cope with the cause of the security vulnerability of a processor of a user, it is possible to perform a barrier control to implement the order guarantee of instruction execution in the RSA, the memory access control circuit, and the memory decoder. As a result, it is possible to prevent the processor from speculatively executing an instruction.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. An arithmetic processing apparatus comprising:
a memory; and
a processor coupled to the memory and configured to:
set a barrier setting condition in a barrier setting condition register,
determine whether or not a fetch instruction satisfies the barrier setting condition set in the barrier setting condition register,
when the fetch instruction satisfies the barrier setting condition, change the fetch instruction into a barrier instruction to be subjected to a barrier control of a barrier attribute corresponding to a satisfied barrier setting condition,
generate an execution instruction by decoding the fetch instruction,
allocate the execution instruction and the barrier instruction to execution queue circuits corresponding to respective instructions,
when a memory access instruction which is one type of the execution instruction is input, execute the memory access instruction in an out-of-order different from the order of programs,
when the barrier instruction is input, perform a control so that a memory access instruction after the barrier instruction is not speculatively executed to overtake the barrier instruction and a predetermined execution instruction corresponding to the barrier attribute before the barrier instruction.

2. The arithmetic processing apparatus according to claim 1, wherein
the barrier attribute has an attribute of branch instruction versus memory access instruction, and
the processor is configured to:
when a fetch instruction corresponding to the barrier attribute of branch instruction versus memory access instruction is a memory access instruction, change the memory access instruction to a barrier instruction for executing a memory access,
when the fetch instruction corresponding to the barrier attribute of branch instruction versus memory access instruction is a first instruction other than the memory access instruction, change the first instruction to a barrier instruction for barrier control after the first instruction, and
when the barrier instruction for executing the memory access and the barrier instruction for barrier control are input, perform a control so that a memory access instruction after the barrier instruction until the processing of a branch instruction before the barrier instruction is completed.

3. The arithmetic processing apparatus according to claim 2,
wherein the processor is configured to issue the memory access instruction after the barrier instruction when the processing of the branch instruction before the barrier instruction is completed.

4. The arithmetic processing apparatus according to claim 1, wherein
the barrier attribute has an attribute of memory access instruction versus memory access instruction, and
the processor is configured to:
when a fetch instruction corresponding to the barrier attribute of memory access instruction versus memory access instruction is a memory access instruction, change the memory access instruction to a barrier instruction for executing a memory access,
when the fetch instruction corresponding to the barrier attribute of memory access instruction versus memory access instruction is a first instruction other than the memory access instruction, change the first instruction to a barrier instruction for barrier control after the first instruction, and
when the barrier instruction for executing the memory access and the barrier instruction for barrier control are input, execute the barrier instruction for executing the memory access and a memory access instruction after the barrier instruction, after the processing of a memory access instruction before the barrier instruction is completed.

5. The arithmetic processing apparatus according to claim 4, wherein the processor is configured to:
when the memory access instruction is input after the barrier instruction,
execute the barrier instruction after a processing of a preceding memory access instruction before the barrier instruction is completed, and
execute the memory access instruction after the barrier instruction after a processing of the barrier instruction is completed.

6. The arithmetic processing apparatus according to claim 1, wherein
the barrier attribute has an attribute of all instructions versus memory access instruction, and
the processor is configured to:
when a fetch instruction corresponding to the barrier attribute of all instructions versus memory access instruction is a memory access instruction, change the memory access instruction to a barrier instruction for executing a memory access,
when the fetch instruction corresponding to the barrier attribute of all instructions versus memory access instruction is a first instruction other than the memory access instruction, change the first instruction to a barrier instruction for barrier control after the first instruction,
when the barrier instruction for executing the memory access and the barrier instruction for barrier control are input, perform a control so that the memory access instruction after the barrier instruction is executed after the processing of all instructions before the barrier instruction is completed.

7. The arithmetic processing apparatus according to claim 6, wherein the processor is configured to:
when an instruction is input in an in-order, complete the processing of the instruction in an in-order,
when a memory access instruction after the barrier instruction is input, execute the barrier instruction after the processing of all instructions before the barrier instruction is completed, and execute the memory access instruction after the barrier instruction after the processing of the barrier instruction is completed.

8. The arithmetic processing apparatus according to claim 1, wherein the barrier attribute has an attribute of all instructions versus all instructions, and
the processor is configured to:
when an instruction is input in an in-order, complete the processing of the instruction in an in-order and change a fetch instruction corresponding to the barrier attribute of all instructions to all instructions to a barrier instruction for executing the corresponding fetch instruction, and
when the barrier instruction is input, based on a completion of the processing, issue all instructions after the barrier instruction after the processing of all instructions before the barrier instruction is completed.

9. The arithmetic processing apparatus according to claim 8, wherein,
the processor is configured to:
when the barrier instruction is input, based on a completion of the processing, issue the barrier instruction after the processing of all instructions before the barrier instruction is completed, and
issue all instructions after the barrier instruction after the processing of the barrier instruction is completed.

10. The arithmetic processing apparatus according to claim 1, wherein the processor is configured to:
speculatively execute an instruction after the barrier instruction at a stage where a branch destination of the branch instruction before the barrier instruction is not determined; and
speculatively execute an instruction after the barrier instruction at a stage where it is determined whether or not the barrier instruction for executing the memory access is an access to an access prohibited area in a memory and a process of trapping and cancelling the barrier instruction for executing the memory access when it is determined that the barrier instruction is an access to the access prohibited area is not completed.

11. The arithmetic processing apparatus according to claim 1, wherein the predetermined execution instruction corresponding to the barrier attribute is one of a branch instruction, a memory access instruction, and all instructions, which is designated with the barrier attribute.

12. An arithmetic processing method executed by a processor included in an arithmetic processing apparatus, the method comprising:
setting a barrier setting condition in a barrier setting condition register;
determining whether or not a fetch instruction satisfies the barrier setting condition set in the barrier setting condition register;
when the fetch instruction satisfies the barrier setting condition, changing the fetch instruction into a barrier instruction to be subjected to a barrier control of a barrier attribute corresponding to a satisfied barrier setting condition;
generating an execution instruction by decoding the fetch instruction,
allocating the execution instruction and the barrier instruction to execution queue circuits corresponding to respective instructions,
when a memory access instruction which is one type of the execution instruction is input, executing the memory access instruction in an out-of-order different from the order of programs,
when the barrier instruction is input, performing a control so that a memory access instruction after the barrier instruction is not speculatively executed to overtake the barrier instruction and a predetermined execution instruction corresponding to the barrier attribute before the barrier instruction.
